(19) United States
(12) Patent Application Publication
(10) Pub. No.: US 2026/0310471 A1
(43) Pub. Date: Oct. 8, 2026

(54) SYSTEMS AND METHODS FOR AUTOMATED ENTERPRISE ORCHESTRATION OF MULTI-PROCESS EXECUTION

(71) Applicant: Robert Lee Johnson, JR., Powder Springs, GA (US)

(72) Inventor: Robert Lee Johnson, JR., Powder Springs, GA (US)

(21) Appl. No.: 19/634,891

(22) Filed: Mar. 31, 2026

Related U.S. Application Data
(60) Provisional application No. 63/783,531, filed on Apr. 4, 2025.

(51) Int. Cl. G06F 9/448; G06T 13/40; G10L 13/02

(52) U.S. Cl. CPC G06F 9/4484; G06T 13/40; G10L 13/02

(57) ABSTRACT

Systems and methods are disclosed for automated orchestration of multi-process execution across enterprise systems. In an embodiment, a method may include operating an insights layer configured to extract system data from natively integrated enterprise systems and generate a current-state data model. The method may also include operating a strategy layer configured to generate a briefing data object comprising a human-readable presentation layer and a machine-executable metadata payload, and transmitting the presentation layer to a user device. The method may also include operating an execution layer configured to parse the metadata payload into machine instructions and transmit activation signals, which may comprise a machine instruction, a routing path, and a shared memory allocation reference, to various execution routines in parallel. The method may also include executing an initiation stage, a discovery stage, a value proposition stage, and a closure stage to automatically orchestrate multi-process execution across functional agents.

### TECHNICAL FIELD

The present disclosure relates generally to enterprise data processing systems and, more particularly, to systems and methods for automated orchestration of multi-process execution.

### BACKGROUND

Enterprise computing systems may assist organizations with various management and operational activities using multiple applications such as customer relationship management tools, human resource information systems, and project management systems. However, executing workflows across disparate enterprise systems in parallel may create race conditions and data contention when multiple processes attempt to read from or write to shared data concurrently. Existing systems may also lack mechanisms for synchronizing execution state across concurrent processes without redundant data extraction, increasing computational overhead and the risk of stale data propagation. Further, existing systems may lack mechanisms for performing conflict detection and constraint evaluation prior to committing computational resources, increasing error rates and wasted processing cycles across execution paths.

### BRIEF DESCRIPTION OF THE DRAWINGS

The accompanying drawings, which are incorporated in and constitute a part of this specification, illustrate several embodiments directed to one of ordinary skill in the art and, together with the description, serve to explain the disclosed principles. It should be noted that, in accordance with standard practice in the industry, various features are not drawn to scale. In fact, the dimensions of the various features may be increased or reduced for clarity of discussion. In the drawings:

FIG. 1 is a block diagram illustrating an exemplary operating environment for implementing various aspects of the present disclosure, according to some embodiments.

FIG. 2 is a block diagram illustrating exemplary layers for the automated orchestration of multi-process execution, according to some embodiments.

FIG. 3 is a schematic diagram illustrating an exemplary system architecture for the automated orchestration of multi-process execution, according to some embodiments.

FIG. 4A is a flowchart illustrating an exemplary initiation stage for automatically orchestrating multi-process execution, according to some embodiments.

FIG. 4B is a flowchart illustrating an exemplary initiation stage for automatically orchestrating multi-process execution, according to some embodiments.

FIG. 4C is a flowchart illustrating an exemplary initiation stage for automatically orchestrating multi-process execution, according to some embodiments.

FIG. 5A is a flowchart illustrating an exemplary discovery stage for automatically orchestrating multi-process execution, according to some embodiments.

FIG. 5B is a flowchart illustrating an exemplary discovery stage for automatically orchestrating multi-process execution, according to some embodiments.

FIG. 6A is a flowchart illustrating an exemplary value proposition stage for automatically orchestrating multi-process execution, according to some embodiments.

FIG. 6B is a flowchart illustrating an exemplary value proposition stage for automatically orchestrating multi-process execution, according to some embodiments.

FIG. 7A is a flowchart illustrating an exemplary closure stage for automatically orchestrating multi-process execution, according to some embodiments.

FIG. 7B is a flowchart illustrating an exemplary closure stage for automatically orchestrating multi-process execution, according to some embodiments.

FIG. 8 is an exemplary graphical user interface (GUI) illustrating a question and answer (Q&A) interaction panel managed by the orchestration routine, according to some embodiments.

FIG. 9 is an exemplary GUI illustrating an interactive strategic presentation interface displaying insights and strategic recommendations rendered on an expert user device, according to some embodiments.

FIG. 10 is an exemplary GUI illustrating an example customer relationship management dashboard, according to some embodiments.

FIG. 11 is an exemplary GUI illustrating an example active engagement sequences interface, according to some embodiments.

FIG. 12 is an exemplary GUI illustrating an example engagement interface, according to some embodiments.

FIG. 13 is an exemplary GUI illustrating an example recruiting dashboard with a Q&A panel, according to some embodiments.

FIG. 14 is an exemplary GUI illustrating an example recruiting dashboard, according to some embodiments.

FIG. 15 is an exemplary GUI illustrating an example job role configuration interface, according to some embodiments.

FIG. 16 is an exemplary GUI illustrating an example open job viewer interface, according to some embodiments.

FIG. 17 is an exemplary GUI illustrating an example candidate tracking interface, according to some embodiments.

FIG. 18 is an exemplary GUI illustrating an example interview interface, according to some embodiments.

FIG. 19 is an exemplary GUI illustrating an example performance goals dashboard, according to some embodiments.

FIG. 20 is an exemplary GUI illustrating an example OKR framework panel, according to some embodiments.

FIG. 21 is an exemplary GUI illustrating an example new goal creation interface, according to some embodiments.

FIG. 22 is an exemplary GUI illustrating an example goal progression interface, according to some embodiments.

FIG. 23 is an exemplary GUI illustrating an example objective interface, according to some embodiments.

FIG. 24 is an exemplary GUI illustrating an example task interface, according to some embodiments.

FIG. 25 is an exemplary GUI illustrating an example call center dashboard with a Q&A panel, according to some embodiments.

FIG. 26 is an exemplary GUI illustrating an example call center dashboard, according to some embodiments.

FIG. 27 is an exemplary GUI illustrating an example call center interface, according to some embodiments.

FIG. 28 is an exemplary GUI illustrating an example campaigns dashboard, according to some embodiments.

FIG. 29 is an exemplary GUI illustrating an example campaign creation plan interface, according to some embodiments.

FIG. 30 is an exemplary GUI illustrating an example campaign creation position interface, according to some embodiments.

FIG. 31 is an exemplary GUI illustrating an example workspace interface, according to some embodiments.

Like reference numerals refer to like parts throughout the several views of the drawings. Reference numbers that are repeated across plural figures are intended to identify the same features in various implementations. Other features of the present embodiments will be apparent from the accompanying drawings and from the detailed description that follows.

### DETAILED DESCRIPTION

The following detailed description is exemplary and explanatory and is not intended to limit the scope of the present disclosure. The description is intended to enable those skilled in art to make and use the disclosed embodiments and is not intended to limit their scope, applicability, or configuration. The accompanying drawings, which are incorporated in and constitute a part of this specification, illustrate exemplary embodiments and, together with the description, explain their principles. Elements in the drawings may be exaggerated for clarity. Well-known methods, components, and techniques are not described in detail so as not to obscure the present disclosure. Although specific details are provided to facilitate understanding, those skilled in the art will recognize that the disclosed embodiments may be practiced without all such details.

The embodiments discussed herein involve automated enterprise orchestration systems using artificial intelligence (AI), which may involve perceiving, synthesizing, inferring, predicting, and generating information using computerized techniques such as machine learning (ML). Disclosed systems may use a combination of hardware and software as a foundation for rapidly performing complex operations to perceive, synthesize, infer, predict, and generate information across vast datasets from disparate enterprise systems. The systems may use one or more models which may have a particular configuration of model parameters and relationships between the parameters. The configuration can change over time as the model learns from input data, which may allow the model to improve its abilities. Powerful combinations of model parameters, sufficiently large datasets from enterprise systems, and high processing capability hardware can produce sophisticated models that could enable systems to digest, interpret, and coordinate information at scales which would otherwise be impracticable or impossible for the human mind to accomplish.

The present disclosure describes systems and methods for providing an automated end-to-end consulting transformation system configurable to orchestrate multi-process execution across multiple enterprise domains. The system can be an autonomous, closed-loop system that can generate strategic insights about the enterprise and directly and automatically execute them. The system may implement a multi-layer architecture comprising an insights layer that integrates enterprise data to establish a current-state data model, a strategy layer that generates interactive strategic briefing with a multi-purpose human-readable and machine-executable data structure, and an execution layer that uses the machine-executable component as a trigger to automatically initiate parallel workflows across functional agents.

Unlike traditional systems which may use isolated applications and may require manual data re-entry, an orchestration routine and an execution routine configured using the techniques disclosed herein can dynamically generate a current-state data model based on extracted organizational data and execute a deterministic operational simulation using machine-readable metadata. In some embodiments, execution routines may be dynamically activated in parallel for various operational tracks or for different functional agents within an enterprise. To facilitate this, the disclosed system may extract organizational data related to a suite of natively integrated enterprise systems, such as accounting, applicant tracking systems (ATS), customer relationship management (CRM), file storage, human resources information systems (HRIS), ticketing, market intelligence, messaging, Objectives and Key Results (OKR) and project management, workspace, revenue cycle management (RCM), learning management systems (LMS), customer experience (CX) call center capabilities, and so forth.

Orchestrating the plurality of enterprise systems so that they can interact automatically, accurately, and/or safely without manual data re-entry of enterprise data is a complex technical problem. To solve this, systems described herein may use one or more specialized data structures. A strategic briefing object is a multi-purpose data structure that simultaneously stores mappings for a human-readable presentation layer and a machine-executable metadata payload. In some embodiments, the presentation layer of the briefing data object may be formatted as a natural-language summary configured for human review on a user device. The metadata payload may be formatted as a structured machine-readable payload using one or more of a JavaScript Object Notation (JSON) format, a data graph, or a domain-specific language, enabling the orchestration routine to programmatically parse and execute the encoded instructions without requiring manual data re-entry.

Once a user approves the presentation layer, the orchestration routine can parse the metadata payload into an OKR initiative record. The OKR initiative record is a machine-readable data structure that can be formatted using a structured schema, such as a JSON format, a data graph, or a domain-specific language, encoding an initiative metadata, OKR alignment scores, strategic risk weighting, resource allocation parameters, and/or operational track designations that may determine which functional agent or agents are activated. The OKR initiative record may be embodied as a cross-functional initiative passing a single record that activates multiple tracks simultaneously. The OKR initiative record may be characterized in that it can be configured to control the operation of the orchestration and execution routines. To determine which functional agent or agents are activated, the orchestration routines may execute a deterministic evaluation that compares the encoded OKR alignment score vectors and strategic risk weighting against predefined threshold parameters within a current-state data model. Based on the deterministic evaluation, the orchestration routine may assign a specific memory pointer to the OKR initiative record, referencing a discrete location within a pre-allocated shared memory allocation, and transmit activation signals in parallel to the designated functional agents.

System can also include an agent activation event data structure. The agent activation event data structure is an inter-agent communication data structure that carries track designations, initiative parameters, and/or execution instructions from the operations agent to each functional agent, in some embodiments. The orchestration routine can transmit the agent activation event to a plurality of functional agents in parallel.

To further improve the functioning of the system, as discussed above, the orchestration routine may use a plurality of functional agents in parallel for executing different operational tracks, using functional agents such as for sales, human resources (HR), operations, CX, marketing, technology, and/or finance agents to execute multi-process work-flows. By assigning a memory pointer to each of the machine instructions and linking each memory pointer to a shared memory allocation to synchronize the functional agents, the system can effectively track cross-functional resource contention in real-time and protect data integrity across previous execution states. The execution routines may generate semaphore or status flag updates to modify the shared memory allocation based on the state of an ongoing process, such as updating an OKR tracking sequence based on previous step in the workflow. To enhance performance and reduce computational resources, the system may incorporate a pre-allocated buffer for the shared memory allocation. The pre-allocated buffer stores execution parameters associated with frequently updated operational tracks linked to previously generated execution results, allowing the system to enable concurrent read access without data duplication and update the current-state data model without repeating the data extraction and manual data entry process. Moreover, the system may intercept errors or failures before they halt execution, executing error-handling logic routines comprising retry sequences or alternative route selections to improve the efficiency of the system and provide for reliable execution.

The disclosed systems and methods may improve the technical field of automated enterprise orchestration and multi-process execution by automating the process required to trigger and coordinate cross-functional execution routines. These systems/methods may further improve the technical field by incorporating a multi-purpose strategic briefing object within the execution process, allowing execution parameters to be provided via a machine-readable metadata payload and also a human-readable presentation layer. Connecting a centralized orchestration routine natively to a plurality of functional agents introduces opportunities for reducing manual data re-entry, tracking shared objectives, and improving system interoperability. Correspondingly, because the multi-process execution is generated by orchestrating the different functional agents that perform their specific functionalities independent of each other in parallel, the routines may be interchangeable in a scalable manner.

The disclosed systems and methods provide technical improvements to computer processing. The assignment of memory pointers to machine instructions, where a machine instruction references a discrete location within a pre-allocated shared memory allocation, solves the technical problem of race conditions and data contention that may arise when multiple execution routines access and modify shared state concurrently among enterprise systems. By linking machine instructions to a specific memory location rather than requiring sequential batch processing, the system may enable concurrent read access across functional agents without data duplication, improving processing throughput and reducing computation overhead compared to conventional sequential enterprise workflow systems. The deterministic evaluation of the machine-executable metadata payload against the current-state data model prior to execution may provide a technical improvement over non-deterministic or heuristic-based approaches by performing constraint evaluation and conflict detection before committing computational resources, which may reduce error rates and prevent invalid execution states. Further, the pre-allocated buffer within the shared memory allocation stores execution parameters associated with frequently updated operational tracks, avoiding repeated data extraction operations and reducing latency across parallel execution threads. Hence, this disclosure may provide technical improvements to memory architecture, parallel processing coordination, and/or deterministic execution.

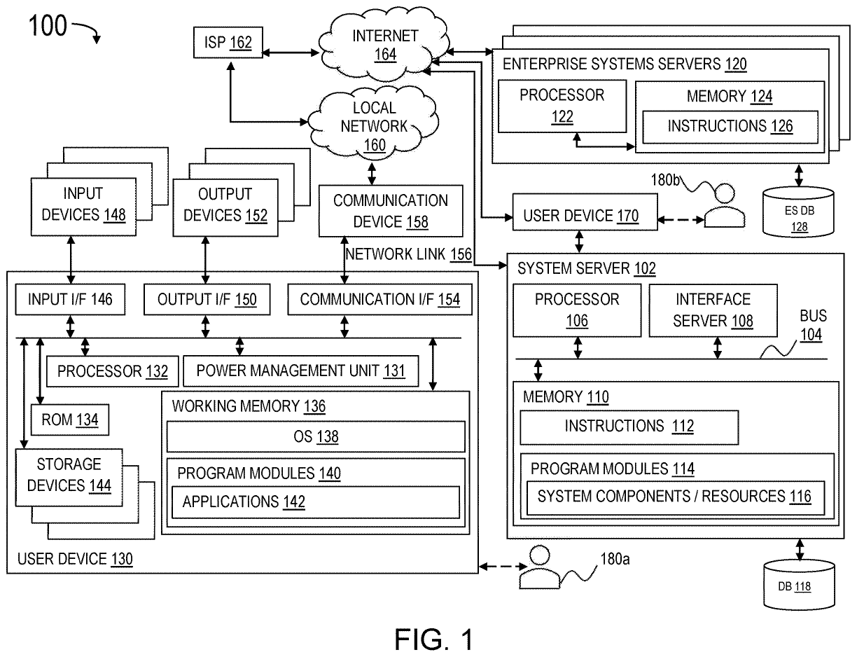

An exemplary operating environment for implementing various aspects of this disclosure is illustrated in FIG. 1. An exemplary operating environment 100 may include a computing device (e.g., client user device 130 and/or system user device 170) in the form of a computer. In some embodiments the computing device may be associated with a user 180a-180b. Components of the user device 130, 170 may include, without limitation, various hardware components much as a power management unit 131, one or more processors 132, storage devices 144, working memory 136, read only memory (ROM) 134, input interface 146, input devices 148, output interface 150, output devices 152, and a system bus that couples (e.g., communicatively couples, physically couples, and/or electrically couples) various system components such that the components may transmit data to and from one another. The system bus may be any of several types of bus structures including a memory bus or memory controller, a peripheral bus, and a local bus using any of a variety of bus architectures. Bus structures may be, for example, Peripheral Component Interconnect (PCI) also known as Mezzanine bus, PCI Express (PCIe), Micro Channel Architecture (MCA) bus, Universal Serial Bus (USB) for external peripherals, Serial Advanced Technology Attachment (SATA) for internal storage devices, Non-Volatile Memory Express (NVMe), Video Electronics Standards Association (VESA) local bus, Industry Standard Architecture (ISA), Enhanced ISA (EISA), proprietary bus, etc.

The illustrated operating environment 100 may include at least one computing device such as a user device 130, 170, system server 102, interface server 108, and/or enterprise systems servers 120. The computing device 130 may be a uniprocessor or multiprocessor computing device. An operating environment 100 may also include one more computing devices in a given computer system which may be clustered, part of a local area network (LAN) 160, part of a wide area network (WAN), client-server network, peer-to-peer networked within the cloud, etc. A computer system may include an individual machine or a group of cooperating machines. A given computing device may be configured for end users (e.g., with applications 142), as a server (e.g., system server 102, interface server 108, enterprise systems servers 120), as a distributed processing node, as a special-purpose processing device, or otherwise configured to train machine learning models, execute orchestration routines, and/or perform parallel multi-process execution. One or more users 180a, 180b may interact with the user device 130, 170 by using a display, keyboard, mouse, microphone, touchpad, camera, sensor, and/or other input devices 148 and output devices 152 via type, text, touch, voice, movement, computer vision, gestures, and/or other forms of input/output. Input/output devices 148, 152 may be removable (e.g., connectable mouse or keyboard) or maybe an integral part of the user device 130, 170 (e.g., a touch screen or a built-in microphone). An input interface 146 and output interface 150 may support interaction between an embodiment and one or more users. A user interface may include one or more of a command line interface, a graphical user interface (GUI), natural user interface (NUI), voice command interface, and/or other user interface (UI) presentations, which may be presented as distinct options or may be integrated. A user may enter commands and information through a user interface or other input devices 148 such as the tablet, electronic digitizer, a microphone, keyboard, and/or pointing device (e.g., mouse, trackball, or touchpad). Additionally, voice inputs, gesture user inputs using hands or fingers, or other NUI may be used with the appropriate input devices, such as a microphone, camera, tablet, touchpad, glove, or other sensor. These and other input devices 148 may be connected to the processor 132 through an input interface 146 that is coupled to the system bus, but may be connected by other interface and bus structures (e.g., a universal serial bus (USB)). A monitor or other type of display device may be also connected to the system bus via the an output interface 150, such as a video interface. The monitor may also be integrated with a touch-screen panel or the like. The monitor and/or touch-screen panel can be physically coupled to a housing in which the computing device is incorporated, such as in a tablet-type personal computer. In addition, computers, such as the user device 130, 170, may also include other peripheral output devices 152, such as speakers and printers, which may be connected through an output peripheral interface or the like.

One or more application programming interface (API) calls may be made between input devices 148, output devices 152, and computing devices (e.g., user device 130, system server 102) based on input received from an interface and/or from networks (e.g., LAN 160, ISP 162, Internet 164). As used throughout, “based on” may refer to being established or founded upon a use of, changed by, influenced by, caused by, or otherwise derived from. In some embodiments, an API call may be configured for a particular API and may be interpreted and/or translated to an API call configured for a different API. As used herein, an API may refer to a defined (e.g., according to an API specification) interface or connection between computers or between computer programs.

System administrators, network administrators, software developers, engineers, and end users are each a particular type of user. Automated agents, scripts, playback software, and the like acting on behalf of one or more people may also constitute a user. Storage devices 144, databases 118, 128, and/or networking devices may be considered peripheral equipment in some embodiments and part of a system comprising one or more computing devices in other embodiments, depending on their detectability from the processor 132, 106, 122. Other computerized devices and/or systems not shown in FIG. 1 may interact with the user device 130, 170 or with another system using one or more connections to a network 160, 164 via a communication interface 154 and a communication device 158, which may include network interface equipment, such as the physical network interface controller (NIC) or virtual network interface (VIF).

User device 130, 170 may include at least one logical processor 132. The user device 130, 170 and other suitable devices may also include one or more computer-readable storage media which may include, but are not limited to, working memory 136, ROM 134, and storage devices 144. In some embodiments, working memory 136 and storage devices 144 may be part of a single memory component. The one or more computer readable storage media may be of different physical types. The media may be volatile memory, non-volatile memory, fixed in place media, removable media, magnetic media, optical media, solid-state media, and/or other types of physical durable storage media (as opposed to merely a propagated signal). In particular, a configured medium such as a portable (i.e., external) hard drive, compact disc (CD), digital versatile disk (DVD), memory stick, or other removable non-volatile memory media may become functionally a technological part of the computer system when inserted or otherwise installed with respect to one or more user devices 130, 170 making its content accessible for interaction with and used by processor(s) 132.

The configured medium may be configured with instructions (e.g., binary instructions) such as program modules 140, applications 142, instructions 112, 126 that are executable by a processor 132, 106, 122. As used herein, “executable” is used in a broad sense to include machine code interpretable code, bytecode, compiled code, and/or other any other code that is configured to run on the machine including a physical machine or a virtualized computing instance (e.g., a virtual machine or a container). The configured medium may also be configured with data which is created by, modified by, reference by, and/or otherwise used for technical effect by execution of the instructions. The instructions and the data may configure the memory or other storage medium in which they reside, such that when that memory or other computer readable storage medium is a functional part of a given computing device, the instructions and data may also configure that computing device.

Although an embodiment may be described as being implemented as software instructions executed by one or more processor in a computing device (e.g., general purpose computer, server, or cluster), such description is not meant to exhaust all possible embodiments. A general-purpose computer, or microprocessor, may be programmed to carry out the algorithm/steps for creating a new machine. The general-purpose computer becomes a special purpose computer once it is programmed to perform particular functions pursuant to instructions from program software of the embodiments described herein. The instructions of the software program that carry out the algorithm/steps electrically change the general-purpose computer by creating electrical paths within the device. These electrical paths create a special purpose machine for carrying out the particular algorithm/steps. One of skill will understand that the same or similar functionality can also often be implemented, in whole or in part, directly in hardware logic to provide the same or similar technical effects. Alternatively or in addition to software implementation, the technical functionality described herein can be performed, at least in part, by one or more hardware logic components. For example, and without excluding other implementations, an embodiment may include other hardware logic components such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to components described above, an operating environment 100 can also include other hardware such as batteries, power management units, power supplies, wired and wireless network interface cards, for instance. The terms “screen” and “display” are used interchangeably herein. A display may include one or more touch screens, screens responsive to input from a pen or tablet, or screens which operate solely for output. In some embodiments, other input devices 148 and output devices 152 will be present in operable communication with one or more processor 132 and working memory 136.

In some embodiments, the system may include multiple computing devices connected by networks. Networking interface equipment can provide access to networks using components such as a packet-switched network interface card, a wireless transceiver, or a telephone network interface, for example, which may be present in a given computer system. However, an embodiment may also communicate technical data indoor technical instructions through direct memory access removable non-volatile media or other information storage retrieval and/or transmission approaches.

The user device 130, 170 may operate in a networked or cloud computing environment using logical connections to one or more remote devices (e.g., using local network 160, ISP 162, Internet 164) such as a remote computer. The remote computer may include one or more of a personal computer, a server, a router, a network PC, or a peer device, or other common network node, and may include any or all of the elements described above relative to the computer. The logical connections may include one or more LANs, WANs, and/or the Internet. When used in a networked or cloud computing environment, user device 130, 170 may be connected to a public or private network through a communication interface 154 or adapter. In some embodiments, a modem, communication device 158, or other communication connection device may be used for establishing connect communications over the network. The modem, which may be internal or external, may be connected to the system bus via a network interface or other appropriate mechanism. A wireless networking component, such as one comprising an interface and antenna, may be coupled through a suitable device such as an access point or peer computer to a network. In the networked environment, program modules 140 depicted relative to the computer, or portions thereof, may be stored in a remote memory storage device. As appreciated, the network connections shown are exemplary and other means of establishing communication links between the computers may be used.

The user device 130, 170 may include any of a variety of computer readable media. Computer-readable media may be any available media that can be accessed by the computer and may include both volatile and non-volatile media, and removable and non-removable media but excludes propagated signals. By way of example and without limitation, computer-readable media may comprise computer storage media and communication media. Computer storage media may include, but is not limited to, RAM, working memory, ROM, electrically erasable programmable read-only memory (EEPROM), flash memory or other memory technology, CD-ROM, DVD, or other optical disk storage, magnetic cassettes, magnetic tape, magnetic disk storage, or other storage devices 144, or any other medium which can be used to store the desired information (e.g., OS 138, program modules 140, applications 142) and which can be accessed by the computer. Communication media may embody computer-readable instructions, data structures, program modules, or other data in a modulated data signal such as a carrier wave or other transport mechanism and may include any information delivery media. The term modulated “data signal” means a signal that has one or more of its characteristics set or changed in such a manner as to encode information in the signal. By way of example and not limitation, communication media may include wired media, such as a wired network or direct-wired connection, and wireless media, such as acoustic, radio frequency (RF), infrared, another wireless media. Combinations of any of the above may also be included within the scope of computer-readable media. Computer-readable media may be embodied as a computer program product, such as software, stored on non-transitory computer-readable storage media.

Storage devices 144 or system memory may include computer storage media in the form of volatile and or non-volatile memory such as ROM 134 and RAM (or working memory 136). A basic input/output system (BIOS), containing the basic routines that help to transfer information between elements within the computer, such as during startup, may be stored in ROM 134. Working memory 136 may contain data and/or program modules 140 that may be immediately accessible to and/or presently being operated on by processor 132. By way of example without limitation, working memory 136 may hold an operating system (OS) 138, applications 142, and other program modules 140, and program data. Storage devices 144 may also include other removable/non-removable, volatile/non-volatile computer storage media. By way of example only, data storage may be a hard disk drive that reads from or writes to non-removable, non-volatile magnetic media, a magnetic disk drive that reads from or writes to a removable, non-volatile magnetic disc, and an optical disk drive that reads from or writes to a removable, non-volatile optical disc such as a CD-ROM or other optical media. Other removable/non-removable, volatile/non-volatile computer storage media that can be used in the exemplary operating environment may include, but are not limited to, magnetic tape cassettes, flash memory cards, digital versatile discs, digital video tape, solid-state RAM, solid-state ROM, and the like. Exemplary disclosed embodiments may include systems, methods, and computer-readable media for the automated orchestration of multi-process execution. For example, in some embodiments, as illustrated in FIG. 1, an operating environment 100 may include user device(s), system server 102, interface server 108, and/or enterprise system servers 120, each respectively comprising a processor, instructions, memory, and system components/resources 116, configured to cooperatively communicate via networks and use shared databases to parse machine readable metadata payloads, orchestrate work-flows, and trigger functional execution routines in parallel.

Some embodiments of this disclosure may be provided in a computer program product, which may be traded between a seller and a buyer as a commodity. The computer program product may include a software program and a computer-readable storage medium having stored therein the software program. For example, the computer program product may include a product, such as a downloadable application, in a software program distributed electronically through a manufacturer of an electronic device or an electronic market. For electronic distribution, at least a part of the software program may be stored on the storage medium or may be generated temporarily. The storage medium may be a storage medium of a server of the manufacturer, a server of the electronic market, or a relay server for temporarily storing the software program. The computer program product may include a storage medium of a server or a storage medium of an electronic device, in a system including the server and the electronic device.

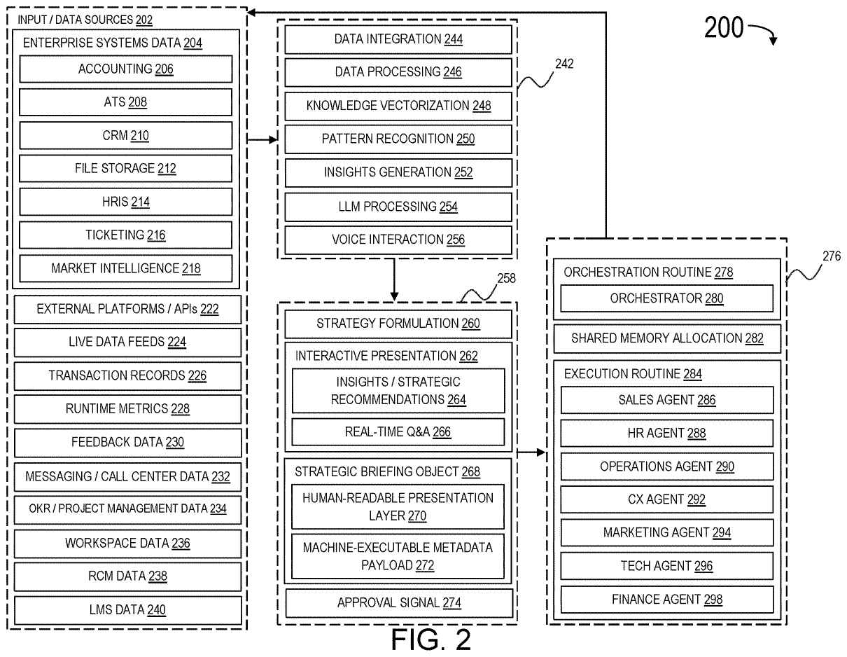

FIG. 2 is a block diagram illustrating an exemplary data flow structure 200 for the automated orchestration of multi-process execution, according to some embodiments. In some embodiments, the structure 200 may be organized into a plurality of layers, which may include, for example, an input layer 202, an insights layer 242, a strategy layer 258, and/or execution layer 276.

The input layer 202 may comprise enterprise systems data 204 extracted from a plurality of natively integrated enterprise systems, including, but not limited to, accounting 206, ATS 208, CRM 210, file storage 212, HRIS 214, ticketing 216, and/or market intelligence 218. The input layer 202 can further include external platforms and APIs 222, live data feeds 224, transaction records 226, runtime metrics 228, feedback data 230, messaging or call center data 232, OKR or project management data 234, workspace data 236, revenue cycle management (RCM) data 238, and learning LMS data 240.

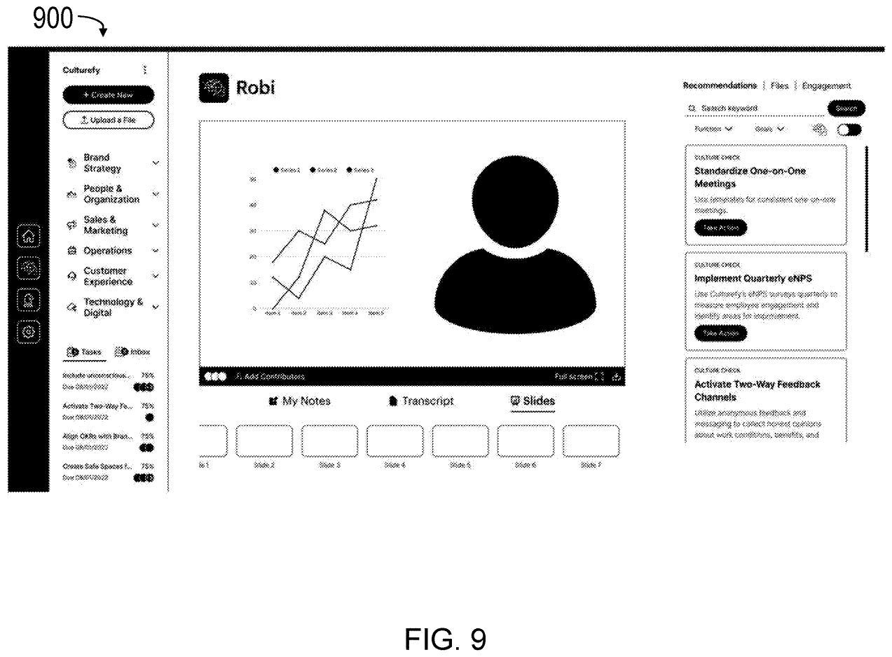

The extracted data may be transmitted to an insights layer 242, which may comprise a data integration module 244 and a data processing module 246 configured to normalize and consolidate disparate data sets. The insights layer 242 may further include a knowledge vectorization module 248 configured to generate vector representations of the processed data, a pattern recognition module 250 configured to identify trends and relationships across the data sets, an insights generation module 252 configured to generate analytical outputs, an LLM processing module 254 configured to apply large language model processing to generate natural language outputs, and/or a voice interaction module 256 configured to capture and process audio inputs from live interactions. FIG. 9 is an exemplary GUI illustrating an interactive strategic presentation interface displaying insights and strategic recommendations rendered on an expert user device, according to some embodiments.

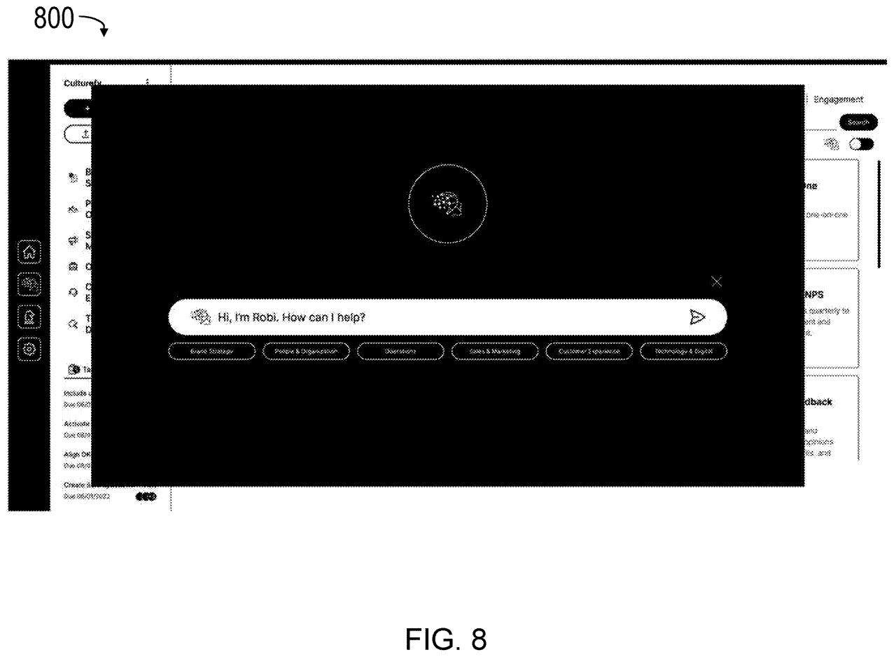

The outputs of the insights layer lay be transmitted to a strategy layer 258. The strategy layer 258 may comprise a strategy formulation module 260 configured to generate strategic recommendations based on the processed data, and an interactive presentation module 262 configured to render insights or strategic recommendations 264 and support real-time Q&A 266 on an assigned expert user device, as shown in FIG. 8. In some embodiments, the interactive presentation module 262 may be configured to render the presentation layer as a digital consultation interface. The interactive presentation module 262 may integrate a speech synthesis, an avatar rendering engine, and an interactive vice response system to conduct a voice-driven dialogue. During the real-time Q&A 266, the voice interaction module 256 may capture live audio queries from the user device. The system may execute real-time NLP and audio transcription to convert the audio into structure machine-readable text arrays, and transmit the text arrays to the LLM processing module 254. The LLM processing module 254 may process the text arrays against the machine-executable metadata payload 272 using a generative AI model to automatically generate a machine-readable response dataset. The speech synthesis and avatar rendering engine may then convert the response dataset into synchronized voice/audio and visual avatar movements. Accordingly, the system may present the strategy briefing object and dynamically answer user questions regarding the recommendations in real time, and the presentation may occur prior to receiving the approval signal via the approval signal interface 274 that triggers the execution layer 276.

The strategy layer 258 may further generate a strategic briefing object 268, which may be instantiated as a multi-purpose data structure comprising a human-readable presentation layer 270, a machine-executable metadata payload 272. The strategy layer 258 can further include an approval signal interface 274 configured to receive an approval signal from a user device to trigger automated execution.

Upon receipt of the approval signal, the system may advance to the execution layer 276. The execution layer 276 may comprise an orchestration routine 278 comprising an orchestrator 280 configured to parse the machine-executable metadata payload 272 and coordinate multi-process execution across a plurality of functional agents. The execution layer 276 may further include a shared memory allocation 282 configured to synchronize state data across the functional agents during parallel execution. The plurality of functional agents may comprise an execution routine 284, including, for example, a sales agent 286, an HR agent 288, an operations agent 290, a CX agent 292, a marketing agent 294, a tech agent 296, and/or a finance agent 298, each configured to execute domain-specific workflows in parallel based on machine instructions derived from the machine-executable metadata payload 272.

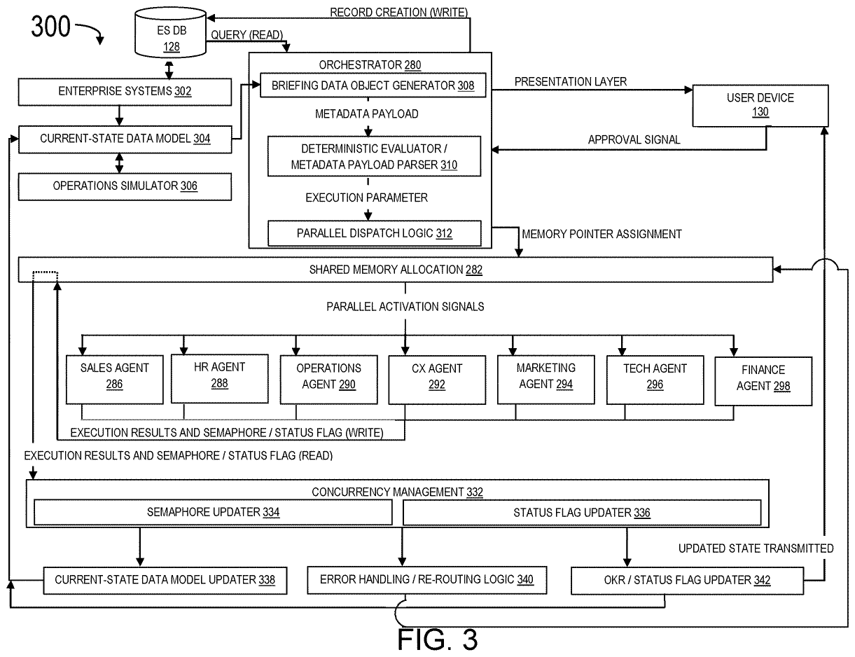

FIG. 3 illustrates a schematic diagram of an exemplary system architecture 300 for the automated orchestration of multi-process execution, according to at least one embodiment of the present disclosure. To help overcome the technical challenges of coordinating isolated applications and manually entering data across disparate platforms, the system architecture 300 may provide an automated end-to-end framework configured to dynamically extract, model, and execute cross-functional workflows in parallel without requiring manual data re-entry. As shown, the system architecture 300 may include enterprise systems 302 communicatively coupled to an enterprise systems database 128. The system may execute queries, for example read operations, to automatically extract organizational data from the natively integrated enterprise systems 302. The extracted data may be used to populate and generate a current state data model 304, which may comprise a relational table, a data graph, a vector representation, or a hierarchical timestamp snap-shot, representing the real-time operational state of the enterprise.

The illustrated system architecture 300 may further include an operations simulator 306 configured to interact with the current state model 304. The operations simulator 306 may execute deterministic operational simulations by applying constraint evaluations and state comparisons to model operational impact under one or more execution parameters.

To bridge the gap between manual decision making and automated machine execution, the system may use a briefing data object generator 308. The briefing data object generator 308 may be configured to generate a multi-purpose data structure (a strategic briefing object) that may simultaneously map to a human readable presentation layer and the machine executable metadata payload. The presentation layer may be transmitted to a user device 130 to enable a user to review the proposed operational tracks.

Upon review, the user device 130 may transmit an approval signal back to the system which may serve as a cryptographic or digital trigger to initiate automatic execution. For example, the approval signal and the generated execution parameters may be received by an orchestrator 280 which may act as the centralized control logic for multi-process workflow routing within the orchestration routine. A deterministic evaluator or metadata payload parser 310 may evaluate the machine-executable metadata payload against the current-state data model 304. In some embodiments, the deterministic evaluation may comprise performing one or more of a threshold comparison, a delta calculation, or a constant-based comparison between values encoded in the metadata payload and corresponding parameters within the current-state data model. For example, a threshold comparison may evaluate whether a resource allocation value exceeds a predefined operational limit, a delta calculation may measure the difference between a current operational metric and a target benchmark, and a constant-based comparison may verify whether an execution condition satisfies a fixed constraint prior to generating an execution parameter. The generated execution parameter may comprise one or more of a resource allocation value specifying computational resources assigned to an execution routine, an execution priority defining the relative scheduling order of parallel machine instructions, a timeout limit governing the maximum duration of an execution routine before an error-handling sequence is triggered, an estimated impact score quantifying the projected operational effect of executing a given machine instruction, or a calculated cost representing the computational or financial expenditure associated with a given execution path.

The parser 310 may parse the metadata payload into a plurality of actionable machine instructions so that parallel processes can be executed safely without data collisions or resource contention. The orchestrator 280 may assign a memory pointer during this process. In some implementations, a specific memory pointer may be assigned to each generated machine instruction, with each memory pointer referencing a secure location within a shared memory allocation 282.

Following the memory pointer assignment, a parallel dispatch logic 312 component may transmit a plurality of parallel activation signals to a suite of designated functional agents 286-298. The functional agents 286-298 may act as modular execution routines 284 configured to carry out domain specific tasks asynchronously or concurrently. The parallel activation signals may be routed to one or more of a sales agent 286, an HR agent 288, an operations agent 290, a CX agent 292, a marketing agent 294, a tech agent 296, and/or a finance agent 298. By transmitting the activation signals in parallel, for example using asynchronous dispatch, thread pools, event loops, or multicore scheduling, the orchestrator 280 may help improve the processing speed throughput of the computer system, providing a technological improvement over sequential batch based processing.

As the functional agents 286-398 execute their respective machine instructions, they may generate execution results, semaphore updates, and/or status flags, which may be written to, and read from, the shared memory allocation 282. The shared memory allocation 282 may comprise a pre-allocated buffer configured to track cross functional resource contention in real time and protect data integrity across various execution states to securely govern the parallelized environment.

System 300 can further include a concurrency management module 332. The concurrency management module 332 may monitor the shared memory allocation 282 and may use a suite of specialized updaters to maintain state synchronization. The updaters may include a semaphore updater 334 and/or a status flag updater 336. System can also include a current state data model updater 338 and/or an OKR/status flag updater 342. For instance, the semaphore updater 334 may prevent race conditions by locking specific data records during write operations; the OKR/status flag updater 342 may track alignment scores and initiative progress based on the metadata payload.

System 300 can further include an error handling or rerouting logic component 340. Rather than halting the entire multi-process execution if a single functional agent encounters a failure or timeout, the error handling or rerouting logic 340 may dynamically intercept the error and execute alternative route selection routines or retry sequences. Thus, the system may provide reliability and/or fault tolerance during automated enterprise orchestration. Once the functional agents 286-398 have reached a successful state transition, the updated state may be transmitted back through the architecture to perform record creation or write operations in the enterprise systems database 128.

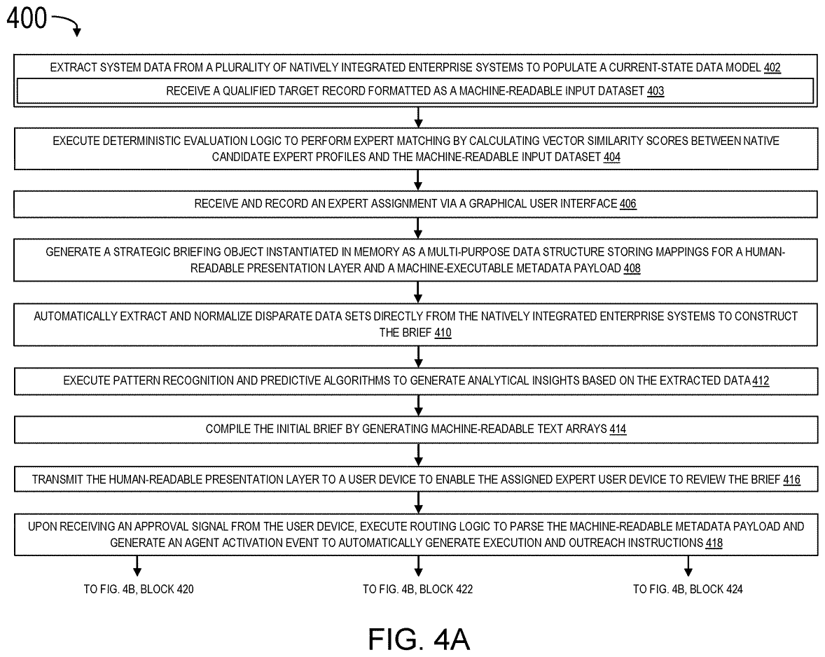

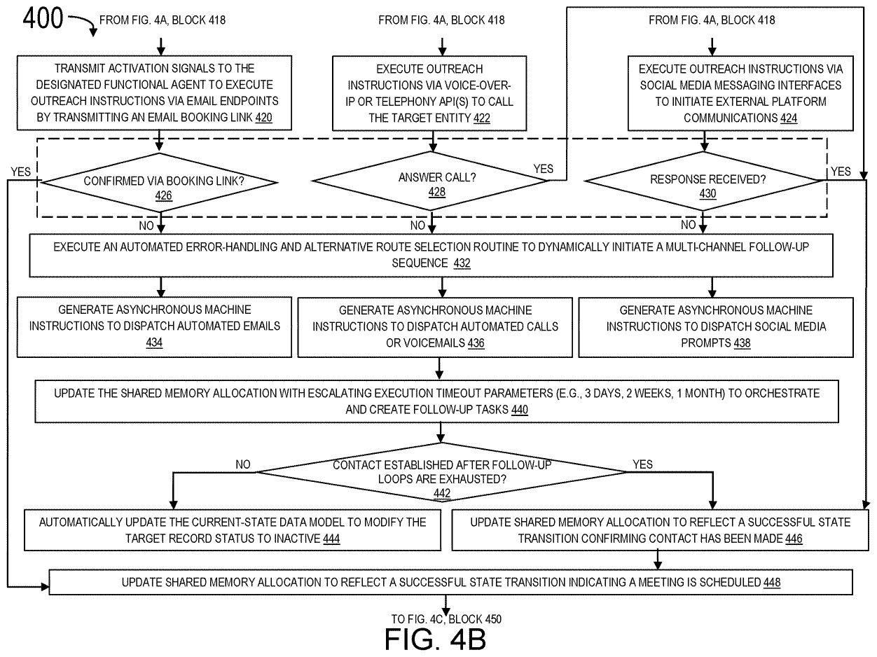

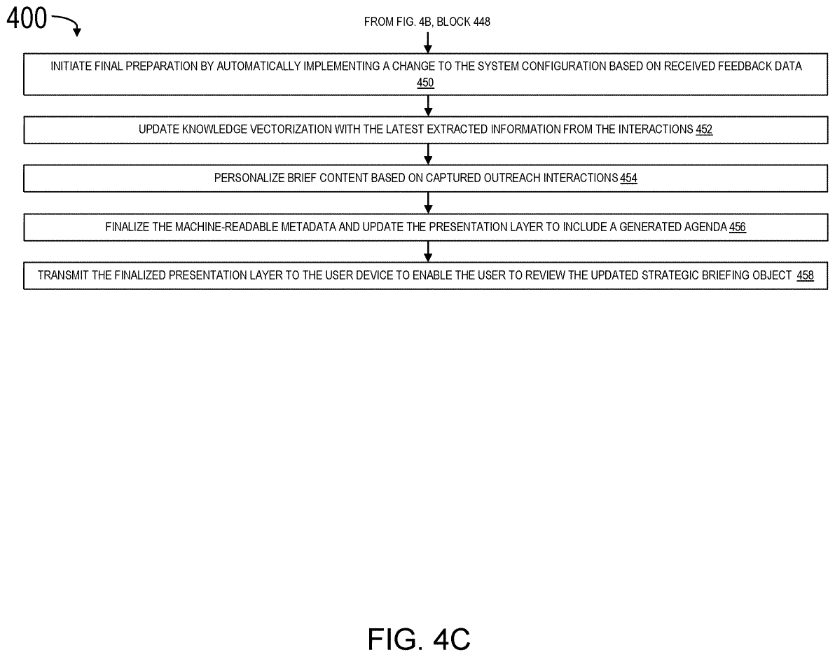

FIGS. 4A, 4B, and 4C are flowcharts illustrating an exemplary initiation stage for automatically orchestrating multi-process execution, according to some embodiments.

As illustrated in FIG. 4A, the method 400 may begin at step 402, where the system may execute instructions to extract system data from a plurality of natively integrated enterprise systems to populate a current-state data model. At step 403, the system may receive a qualified target record formatted as a machine-readable input database. To process the input, at step 404, the system may execute deterministic evaluation logic to perform expert matching by calculating vector similarity scores between native candidate expert profiles and machine readable input dataset. Based on the calculated vector similarity scores, at step 406 the system may receive and record an expert assignment via a GUI.

Once an expert is assigned, the system may bridge human review and automated machine execution at step 408 by generating a strategic briefing object. The strategic briefing object may be instantiated in memory as a multi-purpose data structure storing mappings for both a human readable presentation layer and the machine executable data metadata payload. To accurately populate this object, at step 410 the system may automatically extract and normalize disparate data sets directly from the natively integrated enterprise systems to construct the brief. At step 412, the system may execute pattern recognition and predictive algorithms to generate analytical insights based on the extracted data. At step 414, the system may compile the initial brief by generating machine readable text arrays. At step 416, the system may transmit the human-readable presentation layer to a user device to enable the assigned expert user device to review the brief. At step 418, upon receiving approval signal from the user device, the system may execute routing logic to parse the machine-readable metadata payload and generate an agent activation event to automatically generate execution and outreach instructions.

Turning now to FIG. 4B, the orchestration routine may dynamically dispatch the generated instructions in parallel to designated functional agents. For example, at step 420, the system may transmit activation signals to the designated functional agents to execute outreach instructions via e-mail endpoints by transmitting on e-mail booking link. Concurrently or asynchronously, at step 422, the system may execute outreach instructions via Voice-Over-IP (VoIP) or telephony APIs to call the target entity user device. At step 424, the system could execute outreach instructions via social media messaging interfaces to initiate external platform communications.

During these multi-channel operations, the system may leverage continuous monitoring logic via decision steps 426, 428, 430 to evaluate whether contact has been confirmed via the booking link, if the call was answered, or if a message response was received, respectively. If a positive response is detected, for example the call is answered at step 428 or a response is received at step 430, the system may proceed to step 446 to update the shared memory allocation to reflect a successful state transition confirming that contact has been made. If a meeting is confirmed via the booking link at step 426 or successfully established following contact, the system may proceed to step 448 to update the shared memory allocation to reflect a successful state transition indicating the meeting has been scheduled.

If no response is detected across the initial outreach channels, the system may automatically use asynchronous fall back and error handling mechanisms. For instance, the system may generate asynchronous machine instructions to dispatch automated emails at step 434, dispatch automated calls or voicemails at step 436, or dispatch social media prompts at step 438. At step 440, the system may update the shared memory allocation with escalating execution timeout parameters (e.g., three days, two weeks, one month, etc.) to securely orchestrate, then create necessary follow up tasks, without requiring manual user intervention. At step 432, the system may execute an automated error handling and alternative route selection routine to dynamically initiate a multi-channel follow up sequence.

At step 442, the system may determine whether a contact is successfully established after the automated follow up loops are exhausted. If no contact is established, the system may proceed to step 444 to automatically update the current state data model to modify the target record status to inactive. If contact is established however, the system may advance to step 448.

Referring to FIG. 4C, following the successful scheduling of a meeting, the system may proceed to the final preparation stages. At step 450, the system may initiate final preparation by automatically implementing a change to the system configuration based on the received feedback data. At step 452, the system may update its internal knowledge vectorization with the latest extracted information from the recent interactions. At step 454, the system may personalize the brief content based on the captured outreach interactions that may be relevant. At step 456, the system may finalize the machine readable metadata and update the presentation layer to include a generated agenda. At step 458, the system may transmit the finalized presentation layer to the user device so that the user may review the updated strategic briefing object before the scheduled engagement occurs.

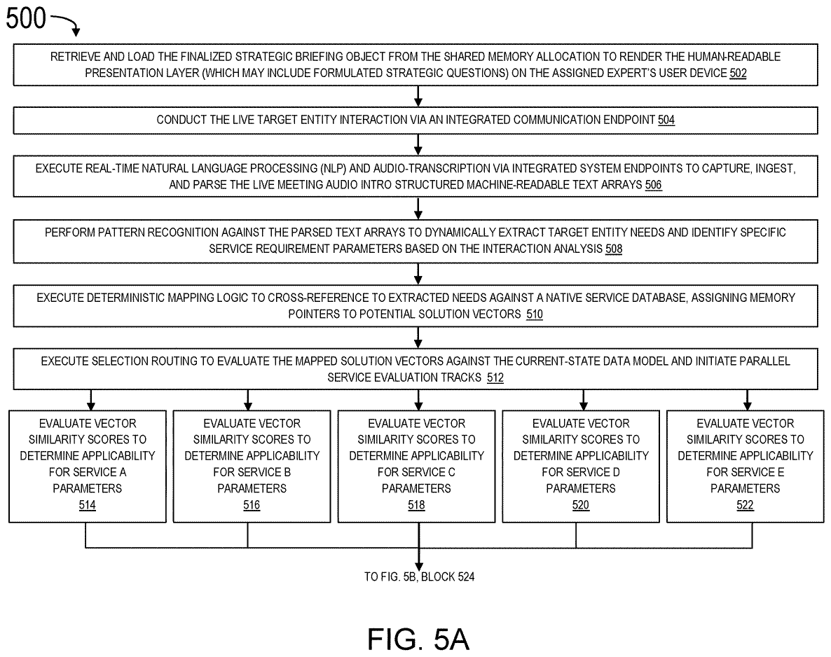

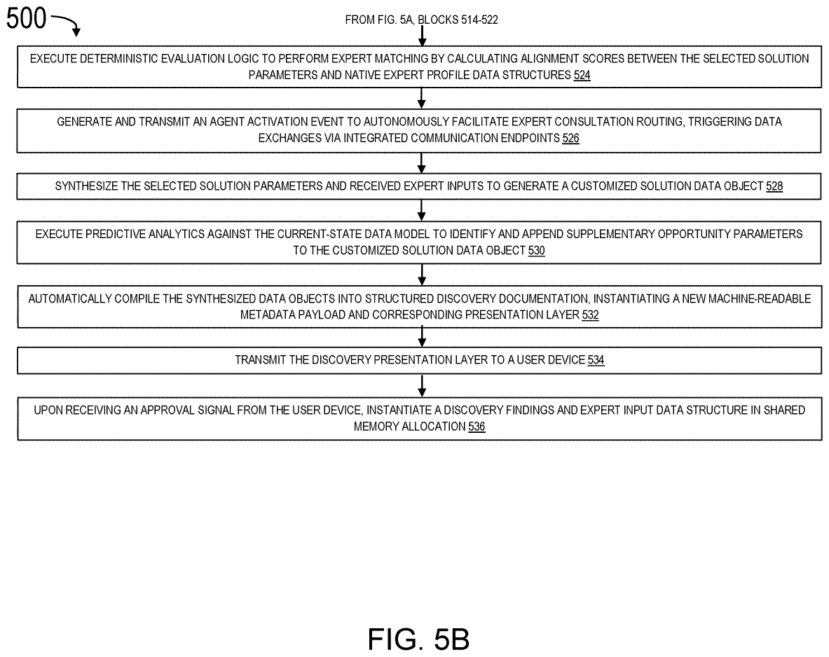

FIGS. 5A and 5B are flowcharts illustrating an exemplary discovery stage for automatically orchestrating multi-process execution, according to some embodiments.

As illustrated in FIG. 5A, the method 500 may begin at step 502, where the system may be configured to retrieve and load the finalized strategic briefing object from the shared memory allocation. The system may render the human readable presentation layer on a GUI, which may include formulated strategic questions on the assigned expert's user device. At step 504, the system may conduct the live target entity interaction via unintegrated communication endpoint. To capture the details of the interaction, at step 506, the system may execute real time NLP and audio transcription via integrated system end-points to capture, ingest, and parse the live meeting audio into structured machine readable text arrays.

Once the text arrays are generated, at step 508, the system may perform pattern recognition against the parsed text arrays to dynamically extract target entity needs. At this step, the system could identify specific service requirement parameters, for example, based directly on the interaction analysis. At step 510, the system may execute deterministic mapping logic to cross reference the extracted needs against the native service database. During the cross referencing process, the system may assign memory pointers to potential solution vectors. At step 512, the system may execute selection routing to evaluate the mapped solution vectors against the current state data model, which may dynamically initiate parallel service evaluation tracks. In an example, the system may use parallel processing logic to evaluate vector similarity scores to determine the applicability for various service parameters. In another example, the system may concurrently evaluate vector similarity scores for service A parameters (step 514), service B parameters (step 516), service C parameters (step 518), service the parameters (step 520), and/or service E parameters (step 522).

As shown in FIG. 5B, at step 524, the system may execute deterministic evaluation logic to perform expert matching by calculating alignment scores between the selected solution parameters and native expert profile data structures. Once an appropriate expert is matched, at step 526, the system may generate and transmit an agent activation event to automatically facilitate expert consultation routing and trigger data exchanges via integrated communication endpoints.

At step 528, the system may synthesize the selected solution parameters and the received expert inputs to generate a customized solution data object. To help maximize the value of the solution, at step 530, the system may make acute predictive analytics against the current-state data model to identify then append supplementary opportunity parameters to the customized solution data object. At 532, the system may automatically compile the synthesized data objects into structured discovery documentation. The compilation process may initially instantiate a new machine readable metadata payload and the corresponding presentation layer. At step 534, the system may transmit the discovery presentation layer to a user device. At step 536, upon receiving an approval signal from the user device, the system may instantiate a discovery findings and expert input data structure in the shared memory allocation, saving the state transition and making the approved parameters available for downstream orchestration workflows.

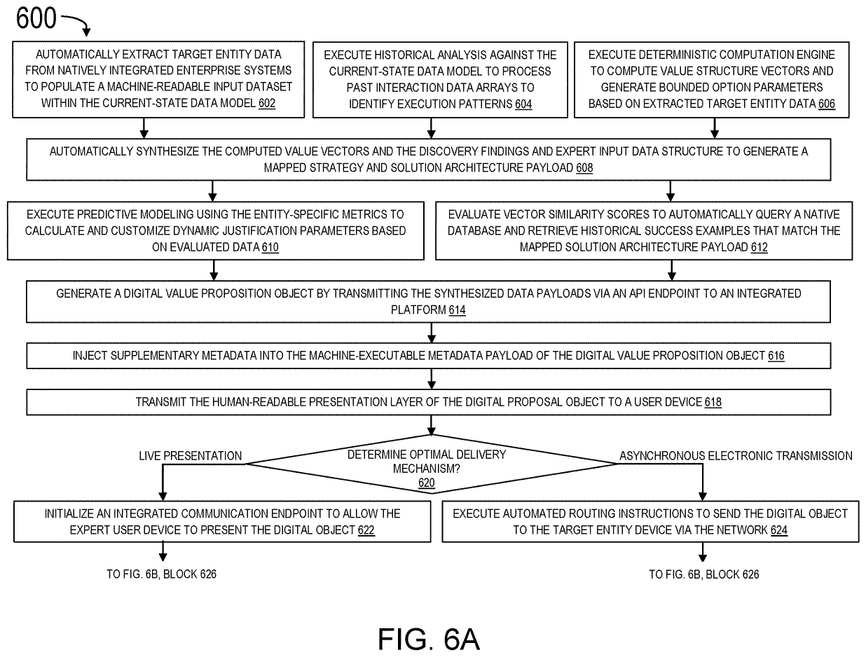

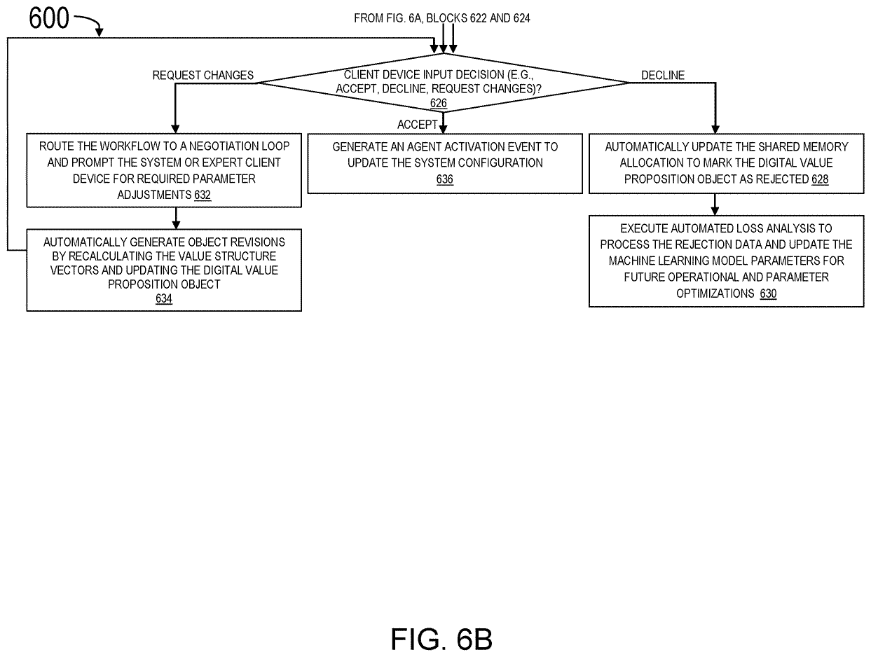

FIGS. 6A and 6B are flowcharts illustrating an exemplary value proposition stage for automatically orchestrating multi-process execution, according to some embodiments.

As illustrated in FIG. 6A, the method 600 may begin at step 602, where the system may automatically extract target entity data from natively integrated enterprise systems to populate a machine readable input data set within the current state data model. At step 604, the system may execute historical analysis against the current state data model to process past interaction data arrays to identify execution patterns. To determine appropriate parameters, at step 606, the system may execute a deterministic computation engine to compute value structure vectors and generate bounded option parameters based on extracted target entity data.

At step 608, the system may automatically synthesize the computed value structure vectors and the discovery findings and expert input data structure to generate a mapped strategy and solution architecture. At step 610, the system may execute predictive modeling using the entity specific metrics to calculate and customize dynamic justification parameters based on the evaluated data. At step 612, the system may evaluate vector similarity scores to automatically query a native database and retrieve historical success examples then match the map solution architecture payload.

Once the data is synthesized and verified, at step 614, the system may generate a digital value proposition object by transmitting the synthesized data of payloads via an API endpoint to an integrated platform. At step 616, the system may inject supplementary metadata into the machine executable metadata payload of the digital value proposition object. At step 618, the system may transmit the human readable presentation layer of the digital proposal object to a user device.

At step 620, the system may determine the optimal delivery mechanism. If the system determines the live presentation is optimal based on, for example, historical or predictive analysis, the system may advance to step 622 to initialize an integrated communication endpoint to allow the expert user device to present the digital object. Alternatively, if an asynchronous electronic transmission is optimal, the system may proceed to step 624 to execute automated routing instructions to send the digital object to the target entity device via the network.

Turning now to FIG. 6B, at step 626, the system may evaluate the client device input decision, which may comprise a decision to accept, decline, or request changes. If the client device inputs a decline decision, the system may proceed to step 628 to automatically update the shared memory allocation to mark the digital value proposition object as rejected. At step 630, the system may execute an automated loss analysis to process the rejection data and update the machine learning model parameters for future operational and parameter optimizations.

If the client device inputs a decision to request changes, the system may proceed to step 632 to route the workflow to a negotiation loop and prompt the system or expert client device for required parameter adjustments. At step 634, the system may automatically generate object revisions by recalculating the value structure vectors and updating the digital value proposition object.

If the client device inputs an accept decision at step 626, the system may advance to step 636, where the system may generate an agent activation event to update the system configuration.

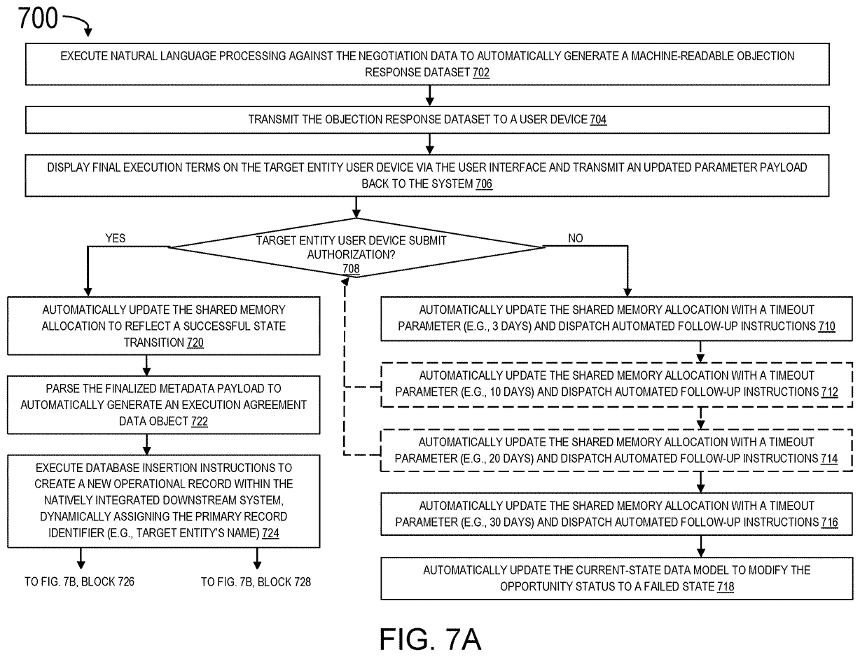

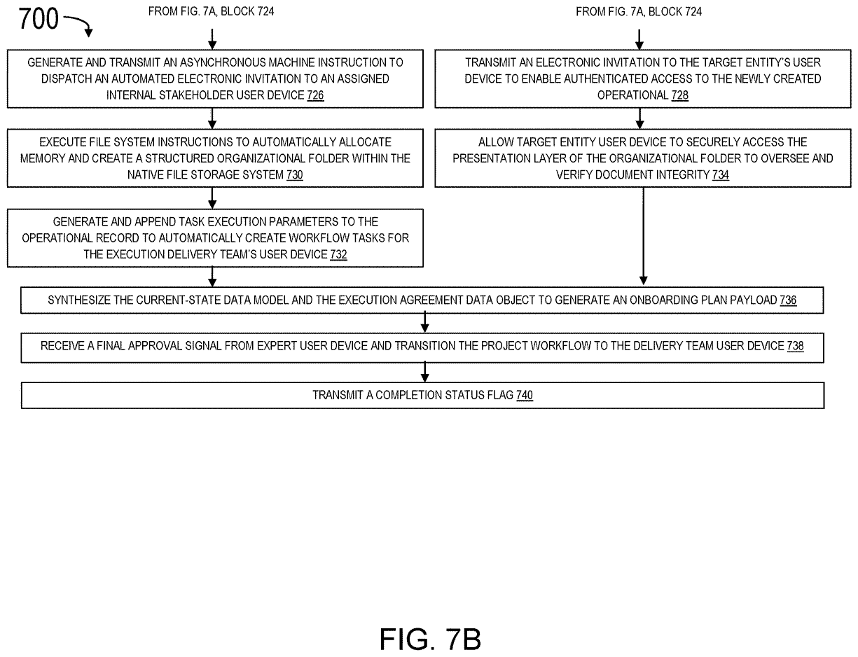

FIGS. 7A and 7B are flowcharts illustrating an exemplary closure stage for automatically orchestrating multi-process execution, according to some embodiments.

As illustrated in FIG. 7A, the method 700 may begin at step 702, where the system may execute natural language processing against the negotiation data to automatically generate a machine readable objection response data set. To enable review, at step 704, the system may transmit the generated objection response data set to a user device. Following the transmission, at step 706, the system may display the final execution terms on the target entity user device via the user interface and transmit an updated parameter payload back to the system.

At step 708, the system may execute logic to evaluate whether the target entity user device has submitted authorization. If the target entity user device does not submit authorization, the system may proceed to execute an asynchronous loop of automated follow-up instructions governed by escalating timeout parameters. For example, at step 710, the system may automatically update the shared memory allocation with the timeout parameter (e.g., 3 days) and dispatch automatic follow up instruction. If the authorization remains unconfirmed, the system may automatically update the shared memory allocation with escalating timeout parameters and dispatch corresponding automated follow up instruction at step 712 (e.g., 10 days), at step 714 (e.g., 20 days), and at step 716 (e.g., 30 days). If the automated follow up sequences are exhausted without receiving authorization, the system may proceed to step 718 to automatically update the current state data model to modify the opportunity status as a failed state.

If the system determines at step 708 that authorization is successfully submitted, the method may advance to step 720, where the system may automatically update the shared memory allocation to reflect a successful state transition. To instantiate the agreement, at step 722, the system may parse the finalized metadata payload to automatically generate an execution agreement data object. Once generated, at step 724, the system may execute database insertion instructions to create a new operational record within the natively integrated downstream system, dynamically assigning the primary record identifier (e.g., the target entity's name).

Referring to FIG. 7B, the method 700 may continue by executing parallel or sequential onboarding and orchestration operations based on the newly created record. At step 726, the system may generate and transmit an asynchronous machine instruction to dispatch an automated electronic invitation to an assigned internal stakeholder user device. Concurrently or sequentially, at step 728, the system may transmit an electronic invitation to the target entities user device so that authenticated access to the newly created operational record may be provided.

At step 730, the system may execute file system instructions to automatically allocate memory and create a structured organization folder within the native file storage system period to provide transparency and verify data integrity, at step 734, the system may allow the target entity user device to securely access the presentation layer of the organizational folder to oversee and verify document integrity. To orchestrate the subsequent downstream tasks, at step 732, the system may generate an append task execution parameters to the operational record to automatically create workflow tests or the execution delivery team's user device.

At step 736, the system may synthesize the current state data model and the execution agreement data object to generate an onboarding plan payload. At step 738, the system may receive a final approval signal from the expert user device and then transition the project workflow to the delivery team user device. At step 740, the system may transmit a completion status flag to the shared memory allocation, confirming the successful state transition and finalizing the onboarding phase for multi process execution.

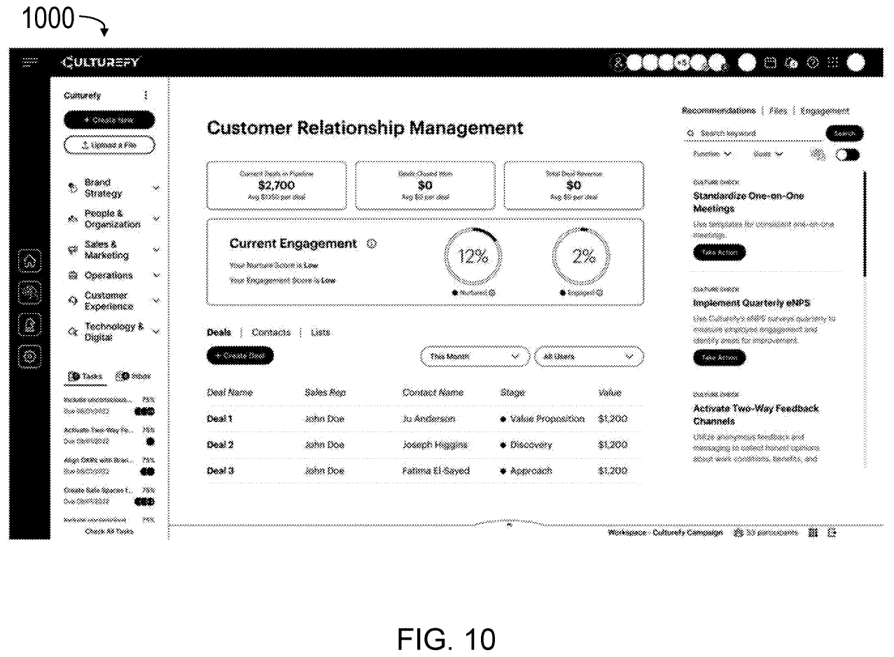

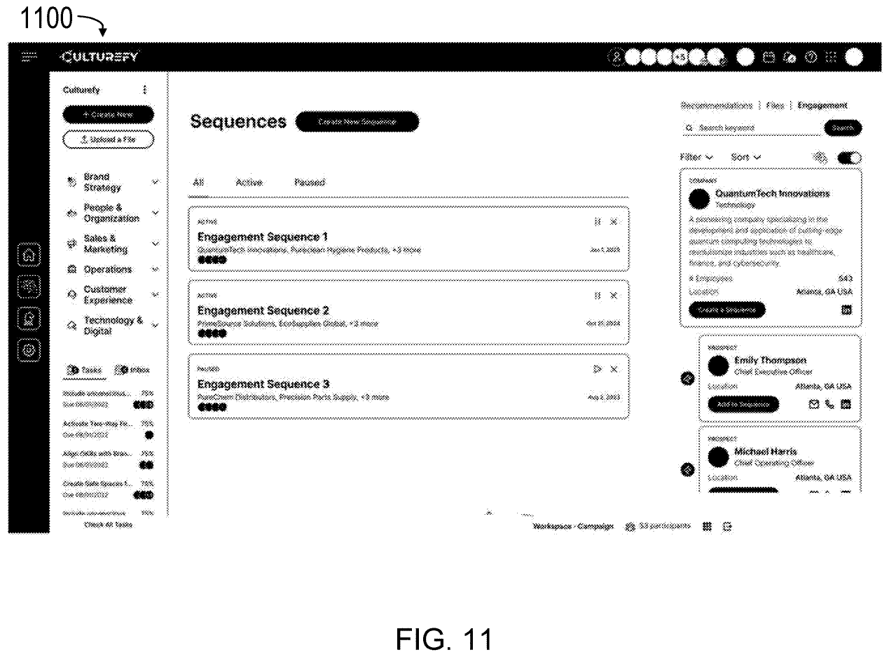

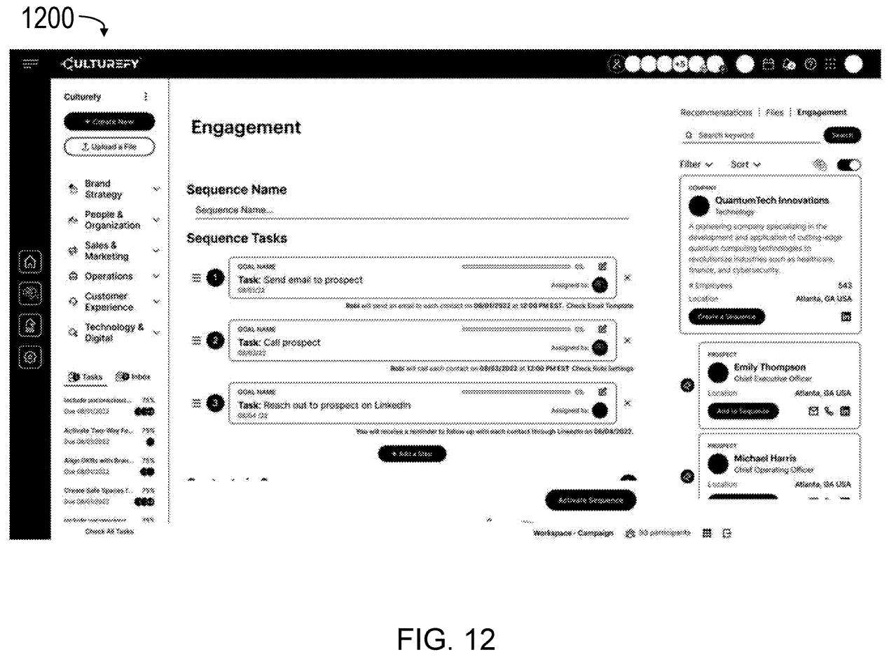

In some embodiments, the plurality of execution routines can include a sales agent 286 configured to execute on automated multi-channel sales and marketing workflow. In this example, the specific target record may comprise a qualified sales opportunity record. The sales agent 286 may automatically extract a normalized disparate datasets comprising, for example, client history, financial data, professional network profiles, and the like directly from connected data sources. During a live client interaction, the sales agent 286 may execute real time natural language processing and audio transcription to ingest meaning audio and parse it into structured machine-readable text arrays to identify the target entity needs, which may comprise client pain points and specific service requirements. The sales agent 286 may execute deterministic computation engines to calculate justification parameters comprising customized return-on-investment (ROI) calculations based on client-specific metrics, and evaluate vector similarity scores to automatically equate a native database to retrieve relevant case studies. Upon synthesizing this data, the sales agent 286 may generate proposition object comprising a digital proposal object. Upon proposal acceptance, the sales agent 286 may parse the metadata payload to automatically generate a digital contract data object and execute database insertion instructions to instantiate a new project record within an integrated project management system. FIG. 10 is an exemplary GUI illustrating an example CRM dashboard, according to some embodiments. FIG. 11 is an exemplary GUI illustrating an example active engagement sequences interface, according to some embodiments. FIG. 12 is an exemplary GUI illustrating an example multi-channel outreach task interface, according to some embodiments.

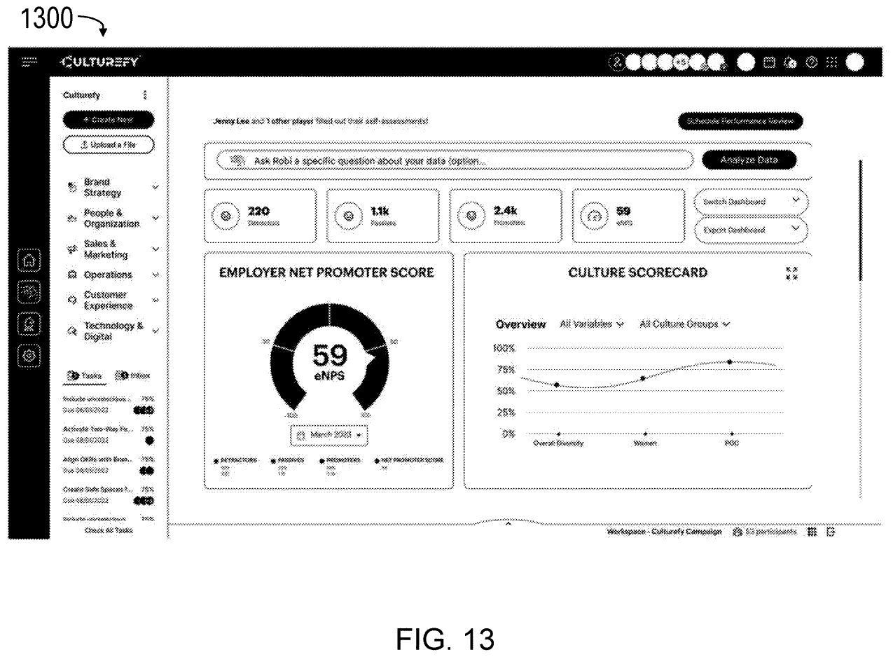

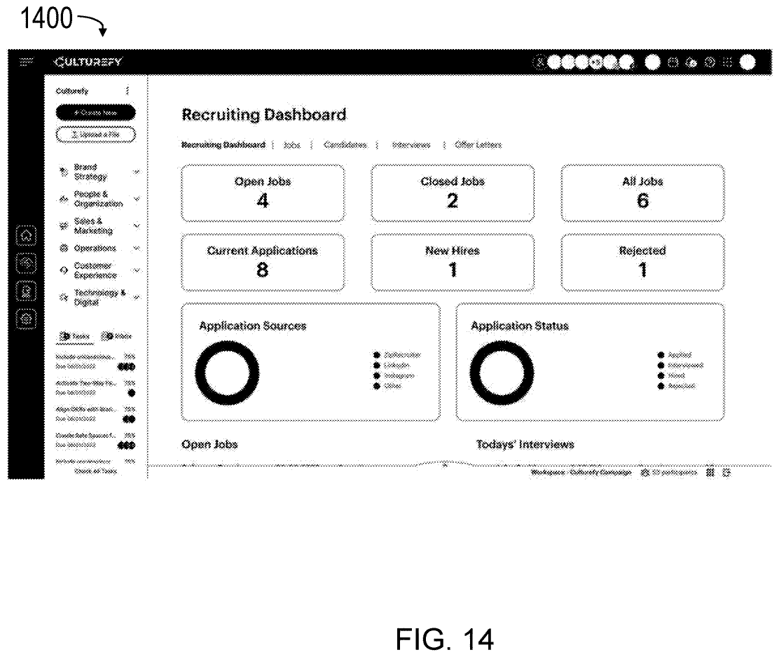

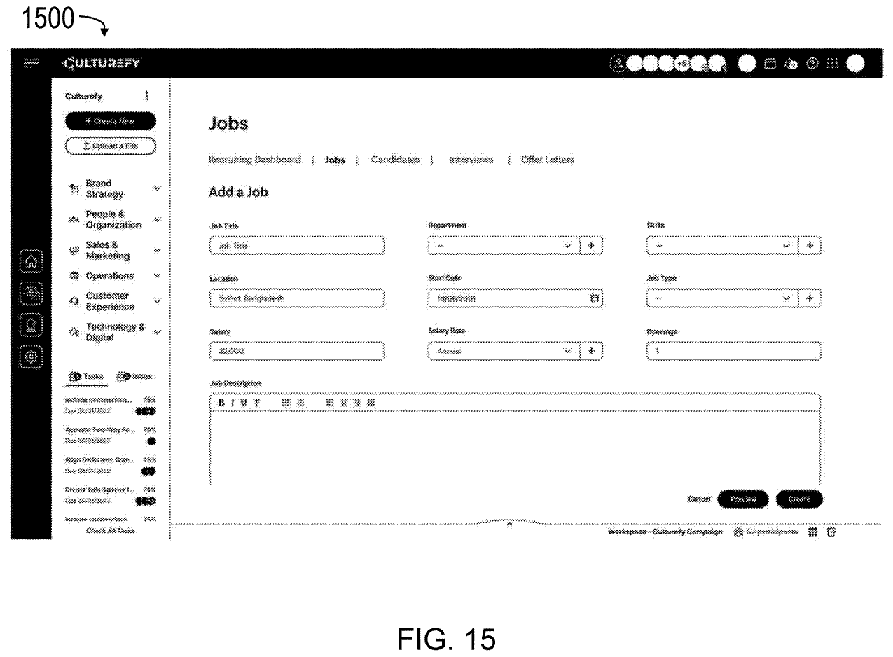

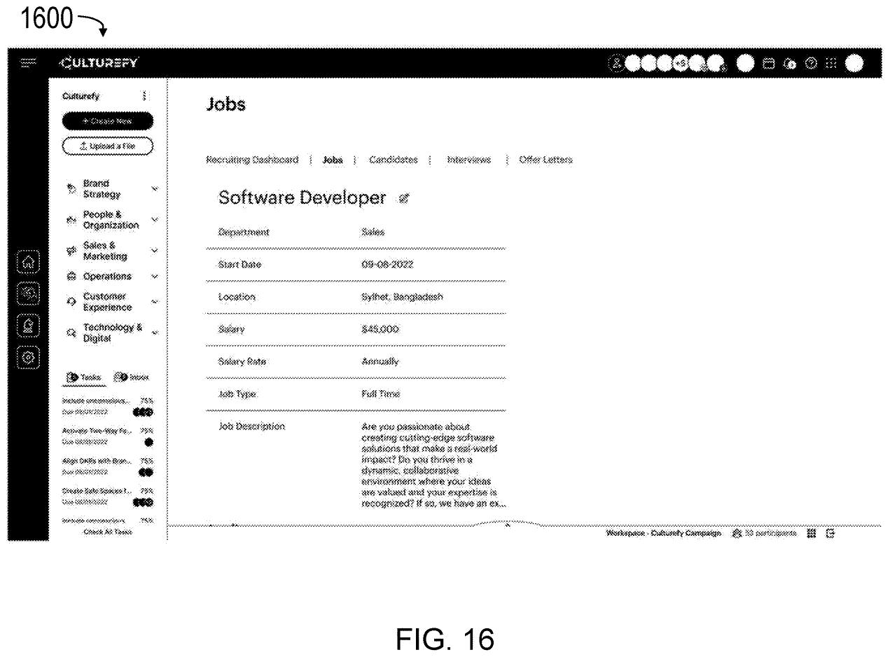

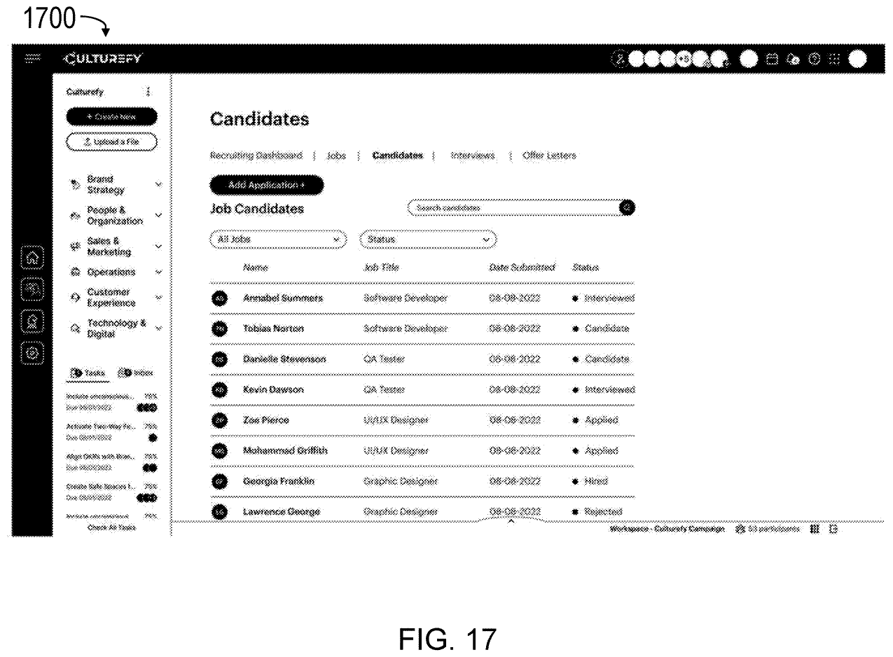

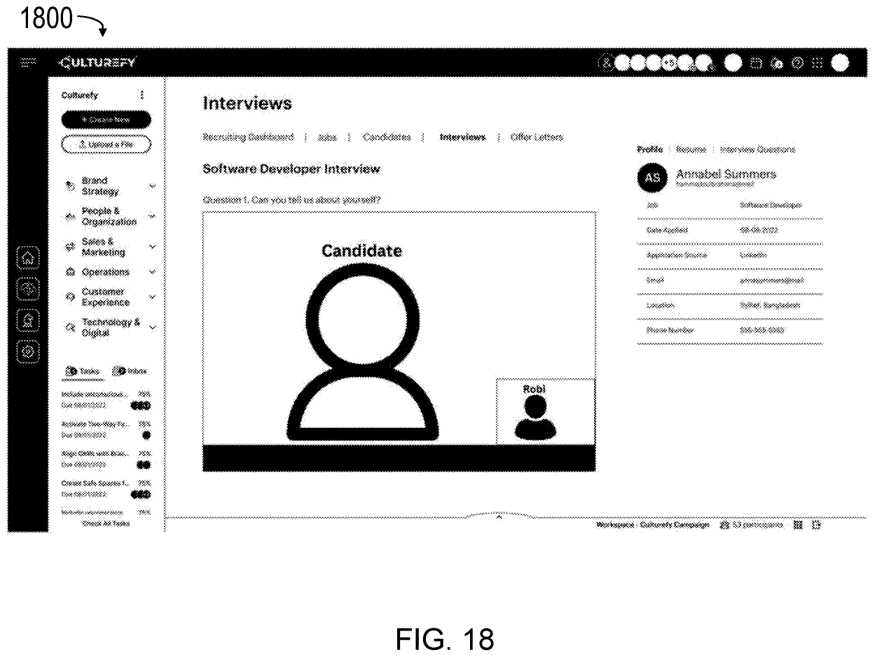

In further embodiments, the plurality of execution routine can include a HR agent 288 configured to execute an automated recruitment and onboarding workflow. The target record may comprise a qualified candidate record, for example. The HR agent 288 may evaluate disparate data sets comprising ATS data, historical interview feedback, and/or professional network profiles. The HR agent 288 may analyze transcribed interview notes to identify the target entity needs, which may comprise candidate goals, competencies, and/or role alignment parameters. The HR agent 288 may execute deterministic job role selection routing to map the competencies against the native HRIS open requisition database and calculate alignment scores to match the candidate with internal job role experts. The HR agent 288 may execute a deterministic compensation engine to calculate justification parameters comprising, for example, dynamic offer justifications based on the evaluated candidate value, generating bounded compensation and benefits scenarios. The system may synthesize the data to generate a proposition object including a digital offer letter or customized role fit proposal data object. Upon offer acceptance, the HR agent 288 may execute database insertion instructions to create a candidate profile in the HRIS and generate an onboarding plan payload. FIG. 13 is an exemplary GUI illustrating an example recruiting dashboard with a Q&A panel, according to some embodiments. FIG. 14 is an exemplary GUI illustrating an example recruiting dashboard, according to some embodiments. FIG. 15 is an exemplary GUI illustrating an example job role configuration interface, according to some embodiments. FIG. 16 is an exemplary GUI illustrating an example open job viewer interface, according to some embodiments. FIG. 17 is an exemplary GUI illustrating an example candidate tracking interface, according to some embodiments. FIG. 18 is an exemplary GUI illustrating an example interview interface, according to some embodiments.

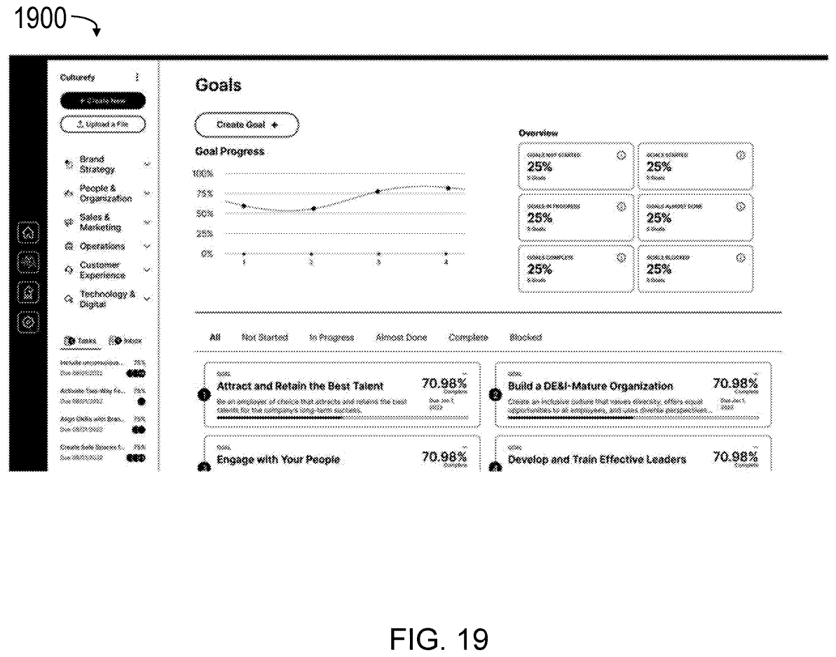

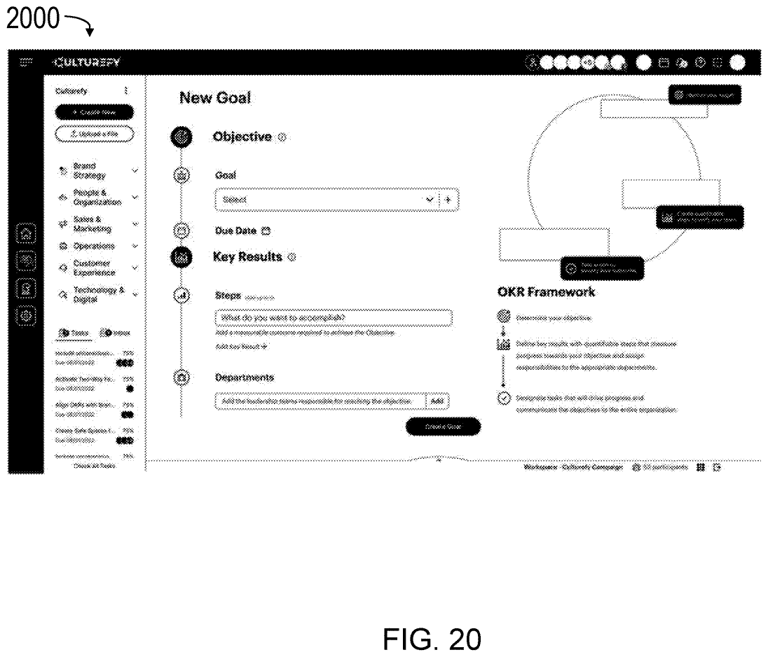

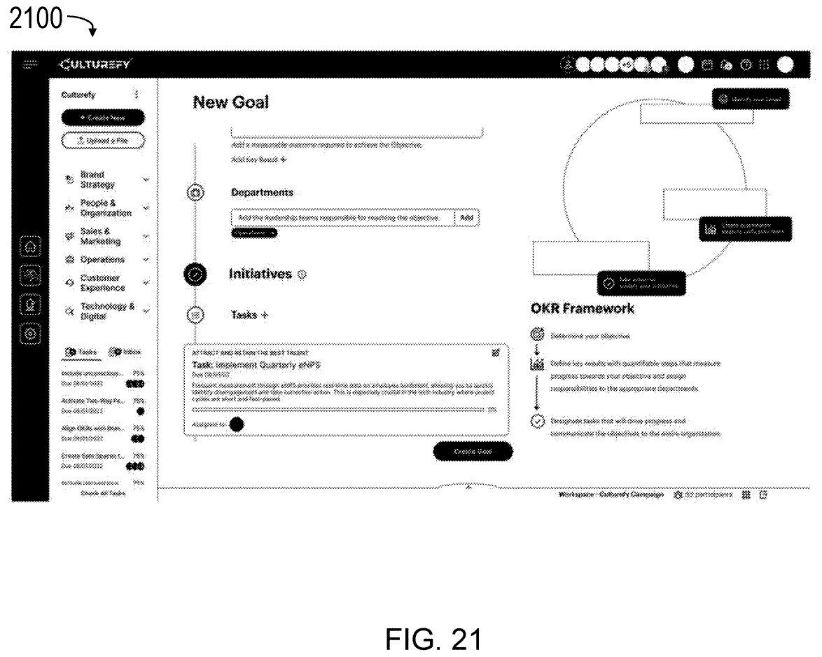

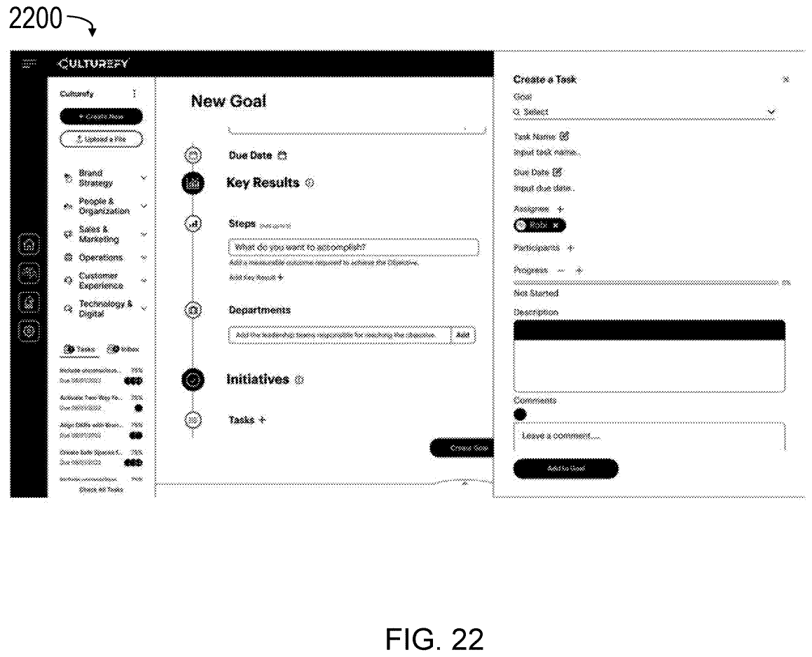

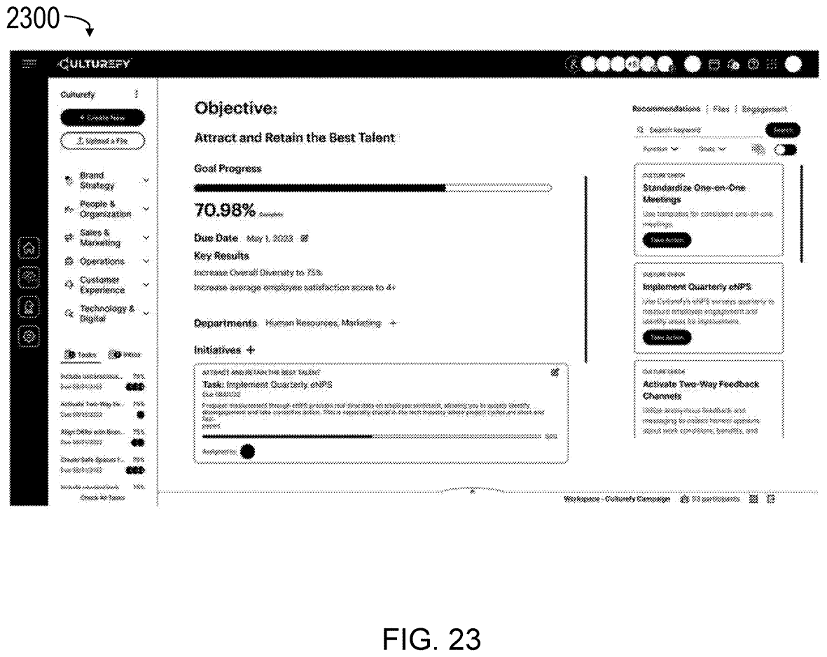

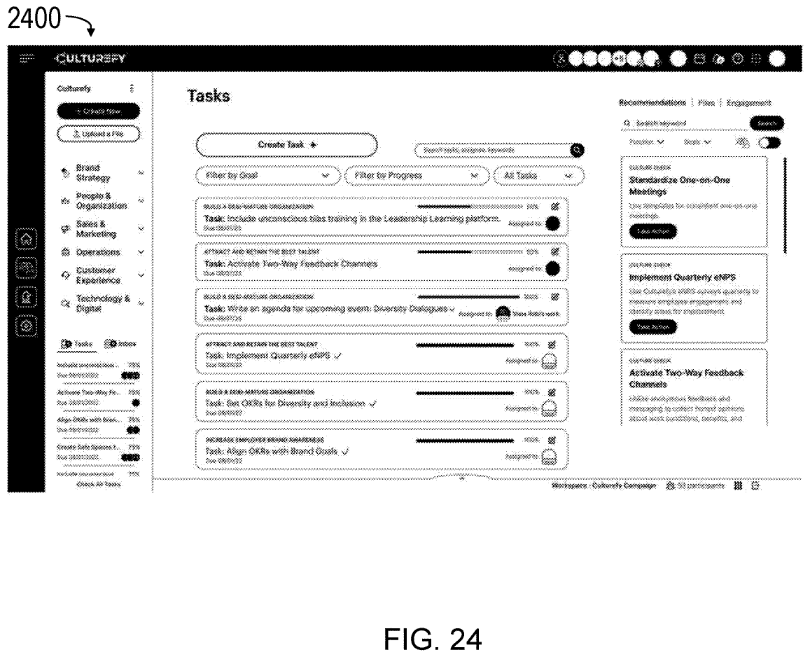

In further embodiments, the plurality of execution routines can include an operations agent 290 configured to orchestrate cross-functional OKR initiative execution. The target record may include an initiative proposal or OKR initiative record. The operations agent 290 may extract disparate datasets comprising past OKR trends, efficiency benchmarks, and/or live operational simulation inputs from natively integrated enterprise systems, for example, from accounting, CRM, ATS, HRIS, etc. The operations agent 290 may analyze the datasets to identify target entity needs such as strategic objectives, workflow capability gaps, and/or resource constraints. The operations agent 290 may generate justification parameters such as forecasted OKR impact scores and/or strategic risk weightings. The data may be synthesized to generate a proposition object comprising an initiative recommendation brief or execution playbook. In some embodiments, the operations agent 290 could serve as the centralized orchestration layer of the system that could trigger other functional agents. Before committing physical computing resources, it may run a deterministic operational simulation against a data-driven representation of the current state data model. For cross-functional initiatives, it may parse the payload into function specific work streams and transmit parallel activation signals to multiple functional agents simultaneously and maintain a single shared OKR tracking sequence in the shared memory allocation. FIG. 19 is an exemplary GUI illustrating an example performance goals dashboard, according to some embodiments. FIG. 20 is an exemplary GUI illustrating an example OKR framework panel, according to some embodiments. FIG. 21 is an exemplary GUI illustrating an example new goal creation interface, according to some embodiments. FIG. 22 is an exemplary GUI illustrating an example goal progression interface, according to some embodiments. FIG. 23 is an exemplary GUI illustrating an example objective interface, according to some embodiments. FIG. 24 is an exemplary GUI illustrating an example task interface, according to some embodiments.

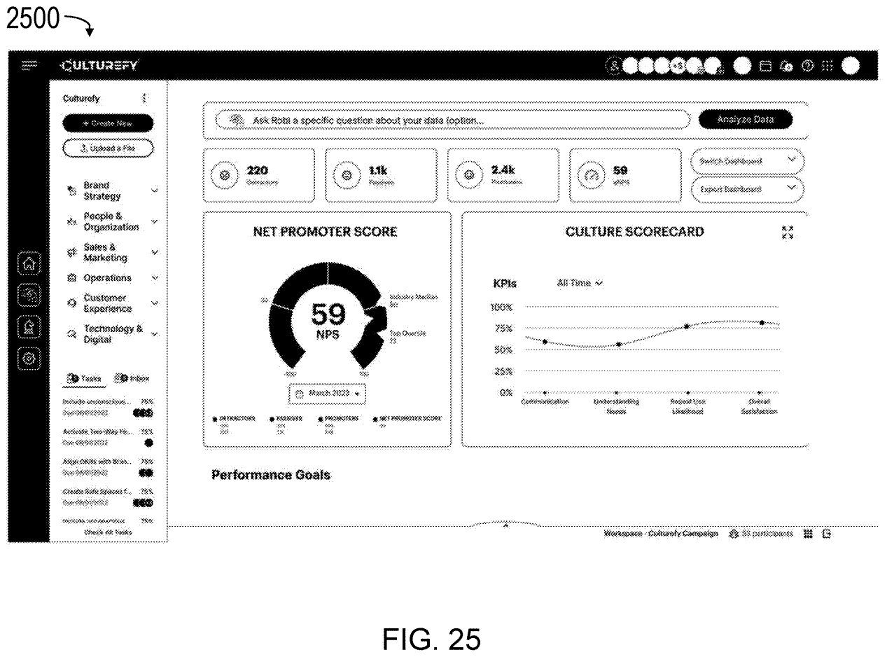

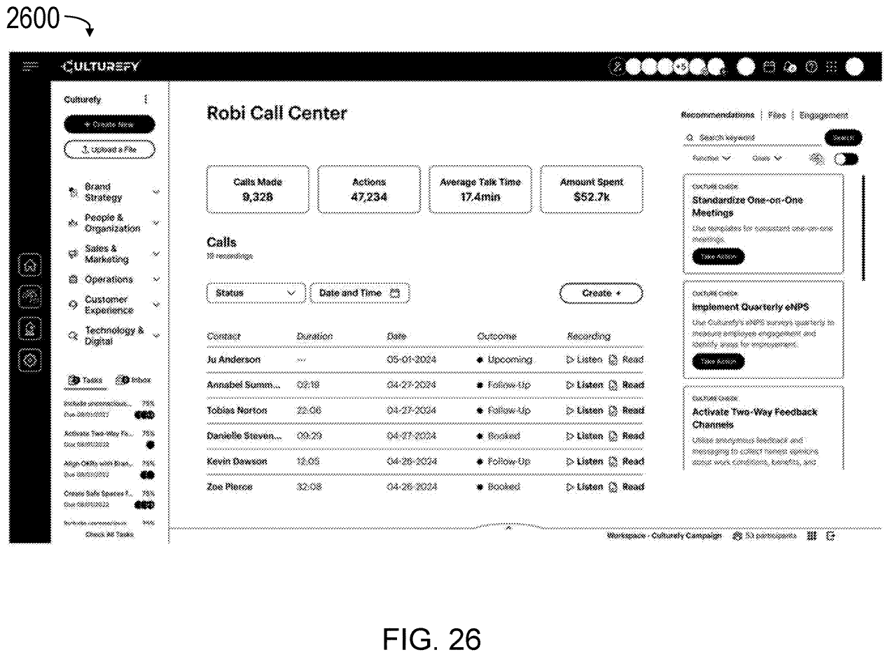

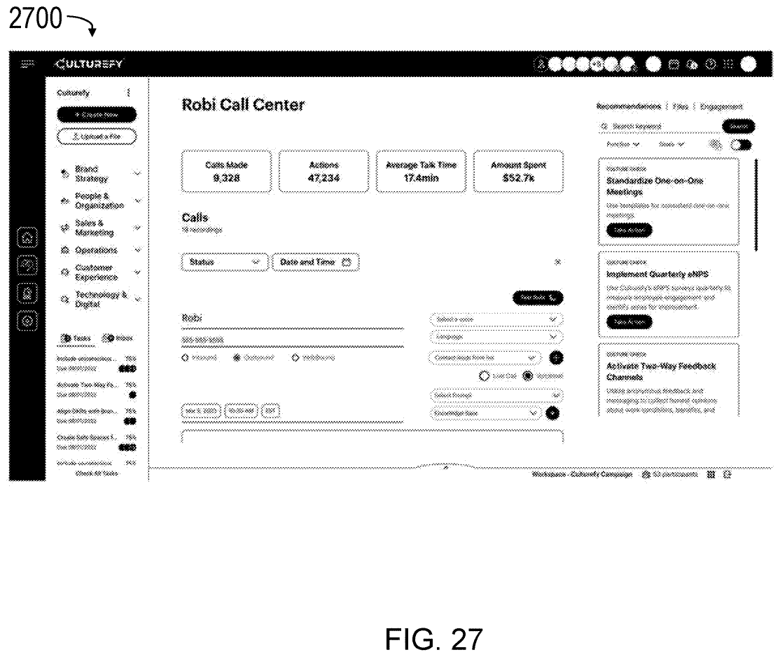

In further embodiments, the plurality of execution routine may further include a CX agent 292 configured to execute automated customer support and issue resolution workflows. The target record may include a detected support need or support case record. The CX agent 292 may analyze disparate datasets comprising customer history, platform usage patterns, pass tickets, and support feedback logs. The CX agent 292 may record and analyze live support conversations, executing root cause identification logic to extract the target entity needs such as technical support requirements and issue resolutions. The CX agent 292 may calculate justification parameters comprising regular resolution justifications based on customer history, business impact, and retrieve examples of similar historical resolutions. Then, the data may be used to generate a proposition object which may include a support plan summary document or resolution plan. The CX agent 292 may evaluate multiple resolution pathways, calculate vector similarity scores to match the specific issue with technical product specialist for fixed validation, and may automatically trigger post resolution retention risk monitoring tasks. FIG. 25 is an exemplary GUI illustrating an example CX dashboard, according to some embodiments. FIG. 26 is an exemplary GUI illustrating an example call center dashboard, according to some embodiments. FIG. 27 is an exemplary GUI illustrating an example call center interface, according to some embodiments.

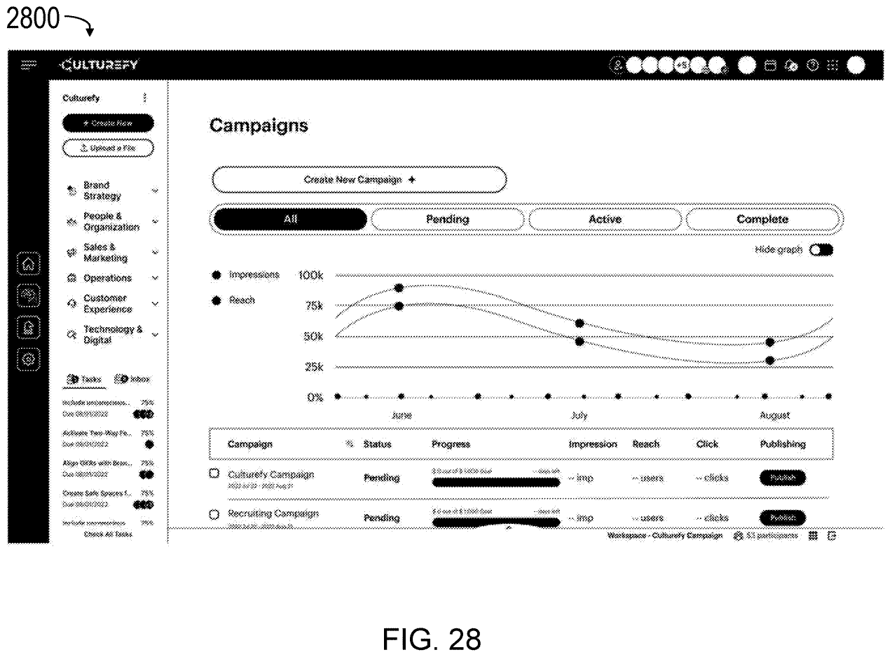

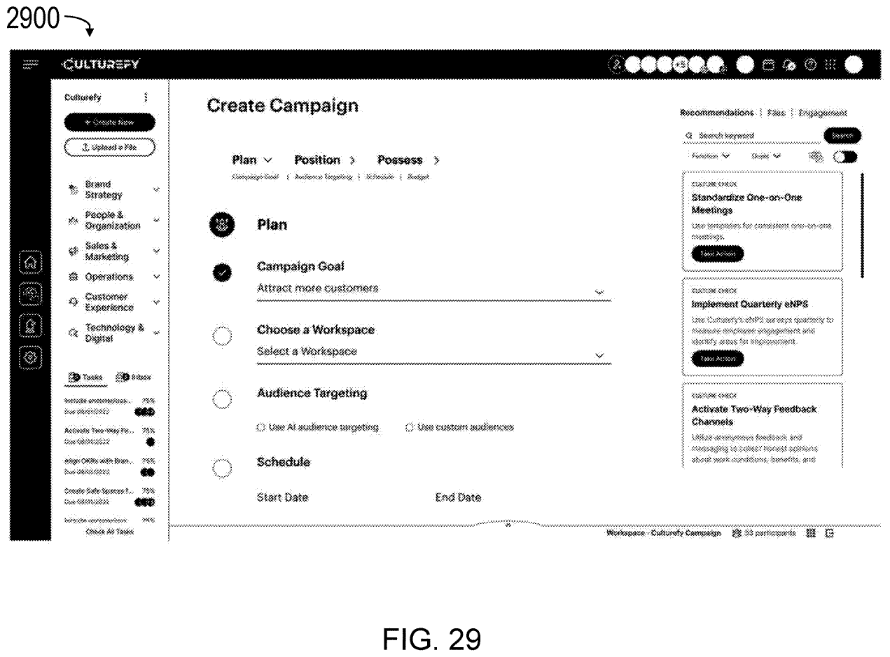

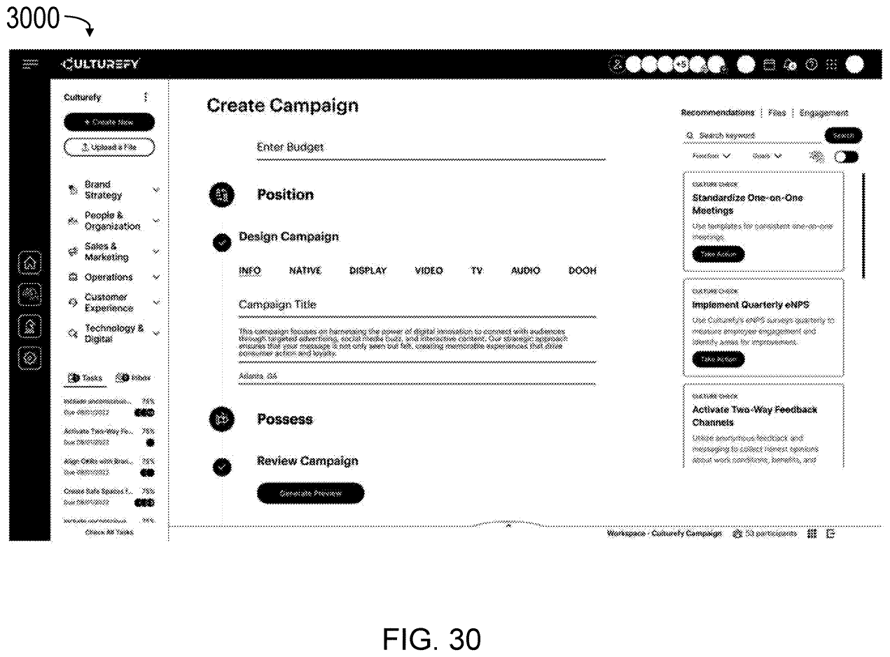

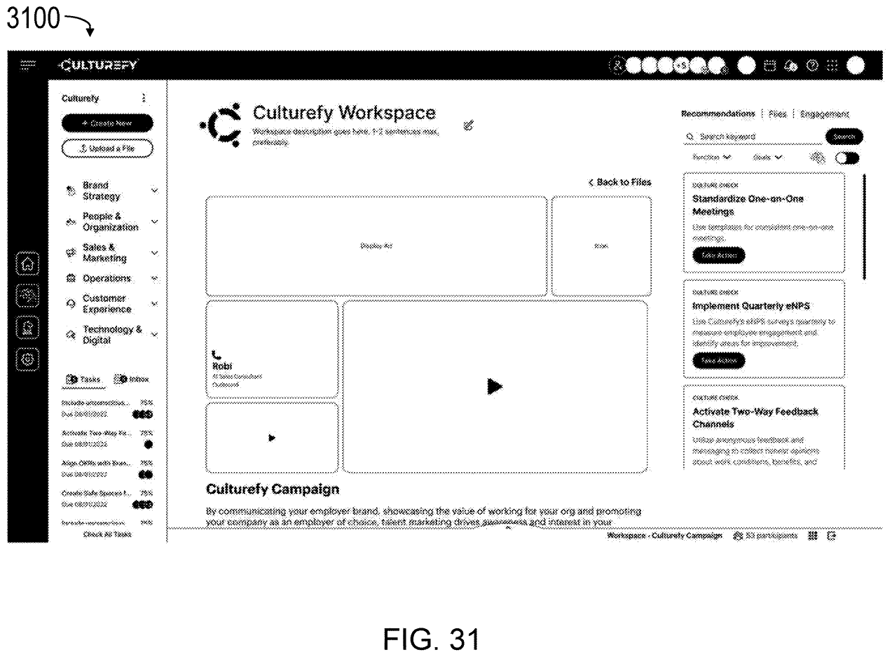

In further embodiments, the plurality of execution routines can include a marketing agent 294 configured to execute automated multi-channel campaign workflows. The target record may comprise a marketing campaign or initiated request. The marketing agent may evaluate disparate datasets such as multi-channel behavior, add engagement trends, past campaign performance, and targeting signals. The marketing agent 294 may perform pattern recognition to extract target entity needs comprising personal targets segments, campaign goes, and/or target engagement metrics. The marketing agent may generate justification parameters such as campaign justifications based on strategic marketing objectives and engagement forecasting derived from native client data models. System can generate a proposition object such as a final campaign summary, which may include an automatically generated creative matrix and publishing plan. The marketing agent 294 may tailor ad experiences for specific personnel segments, recommend channel mixes in personalization logic by platform, execute file system instructions to generate a campaign management folder with creative assets, and establish automated post launch uptime monitoring and add performance synchronization. FIG. 28 is an exemplary GUI illustrating an example campaigns dashboard, according to some embodiments. FIG. 29 is an exemplary GUI illustrating an example campaign creation plan interface, according to some embodiments. FIG. 30 is an exemplary GUI illustrating an example campaign creation position interface, according to some embodiments. FIG. 31 is an exemplary GUI illustrating an example workspace interface, according to some embodiments.

In further embodiments, the plurality of execution routine can include a technology agent 296 configured to execute automated digital infrastructure and modernization workflows. The target record may include a technology directive, system alert, or digital experience brief. The technology agent 296 may audit the disparate datasets such as past site data, existing templates, platform capabilities, and historical system performance metrics. The technology agent 296 may conduct digital maturity benchmarking to identify target entity needs such as technology gaps, redundancies, and/or integration requirements. The technology agent 296 may execute computation engines to generate justification parameters comprising customized ROI calculations for technology investments and bounded cost structures for build, buy, or integrate scenarios. The system may generate a proposition object comprising a technology proposal, solution architecture document, or implementation task list. The technology agent 296 may execute a multi-system deployment sequence, automatically configuring system integrations and deploying automation workflows across the enterprise without manual developer reconfiguration.

In further embodiments, the plurality of execution routines can include a finance agent 298 configured to execute automated budget, billing, accounts payable (AP), accounts receivable (AR), and accounting reconciliation workflows. The target record may include an internal budget request or client building in tag record. The finance agent 298 may evaluate the disparate datasets comprising historical spend data, client agreements, and/or financial request data extracted from native enterprise resource planning (ERP) or budget tools. The finance agent 298 may execute deterministic computation engines to identify target entity needs comprising budget allocation, billing reconciliation, and/or cost scenario constraints. The finance agent 298 may calculate justification parameters such as refined financial forecasting models and historical span variance justifications. The system may parse this data to generate a proposition object comprising a financial briefing object, client agreement, and/or a finalized budget authorization. The finance agent 298 in some embodiments may include bookkeeping automation, executing programmatic sequences for AP, AR, and large scale ledger reconciliation, for example, automatically clearing massive backlogs of billing records with high accuracy. Upon financial plan approval, the finance agent may parse the metadata payload to execute database insertion instructions, creating financial records directly within a natively integrated ERP system in dispatching automated tasks to the reconciliation team.

Although the invention has been explained in relation to its preferred embodiment, it is to be understood that many other possible modifications, variations, adaptations, combinations, and equivalent arrangements can be made without departing from the spirit and scope of the present disclosure. Features described in connection with one embodiment may be combined with, substituted for, or implemented independently of features of other embodiments unless expressly restricted or context clearly indicates otherwise. The disclosed systems, methods, and/or processes are not limited to any particular order, configuration, or sequence unless expressly stated or context clearly indicates otherwise. Steps described in the drawings or the description may be performed sequentially, in parallel, concurrently, or in different order.

The scope of protection is to be interpreted in accordance with the ordinary meaning of the claim language as understood by a person of ordinary skill in the art in light of the specification and prosecution history. Terms are given their ordinary and customary meaning unless expressly defined otherwise. Dictionary definitions that conflict with context usage do not control. Nothing in the specification is intended to read limitations into the claims that are not expressly recited.

Unless otherwise indicated, all numerical values, measurements, and/or specifications are approximately and include reasonable variations consistent with their intended function and customary practice in the art. Numerical ranges include all values and subranges within the stated range, including endpoints. The term “about” or “approximately” indicates reasonable measurement variability, including variations arising from standard measurement techniques.

Disjunctive phrases such as “A or B,” “A and/or B,” “at least one of A and B,” and so forth include any one of the listed elements or any combination thereof. Commas and slashes (/) likewise denote “and/or.” Ordinal terms such as “first,” “second,” “third”, etc., are used for distinction only and do not imply priority or sequence, unless expressly stated or context clearly indicates otherwise. Relational terms such as “connected” or “coupled” include direct and indirect relationships unless stated as “directly.” Terms such as “between” or “on” encompass both direct and indirect arrangements unless expressly limited. References to an element being “between” or “on” another element do not exclude intervening elements unless expressly stated or context clearly indicates otherwise. Spatial and/or directional terms describe relative relationships as illustrated and encompass alternative orientations in use.

The terms “comprise,” “include,” and similar variations denote non-exclusive inclusion. The use of “a” or “an” does not preclude additional identical elements unless expressly limited. The term “unit” may indicate a hardware component such as a processor or a circuit, and/or may indicate a software component that is executed by a hardware configuration such as a processor. Terms such as “system,” “device,” or “module” are not limited to any particular number, configuration, and/or physical arrangement of components. Such elements may be implemented as a single unit or distributed across multiple components, devices, circuit boards, and/or substrates, and may include movable or static elements.

What is claimed is:

1. A system, comprising:
a non-transitory memory storing instructions;
a processor configured to execute the instructions to perform operations for automatically orchestrating multi-process execution, the operations comprising:
extracting system data from a plurality of enterprise systems;
generating a current-state data model based on the system data;
generating a briefing data object comprising a presentation layer and a metadata payload, wherein the metadata payload comprises an Objective and Key Results (OKR) initiative record data structure encoding an initiative identifier, a plurality of objective alignment scores, and a strategic risk weighting;
transmitting the presentation layer to a user device for display on a display of the user device;
receiving an approval signal from the user device associated with the presentation layer;
executing, in response to the approval signal, a deterministic evaluation of the metadata payload against the current-state data model to generate an execution parameter;
parsing, based on the execution parameter, the metadata payload into a plurality of machine instructions using an orchestration routine;
assigning a memory pointer to each machine instruction, each memory pointer referencing a location within a shared memory allocation; and
transmitting a plurality of activation signals to a plurality of execution routines in parallel, wherein each of the plurality of activation signals comprises a machine instruction of the plurality of machine instructions and a routing path identifying a respective execution routine.

2. The system of claim 1, wherein the briefing data object comprises the presentation layer formatted as a natural-language summary and the metadata payload formatted as a structured machine-readable payload using one or more of a JSON format, a data graph, or a domain-specific language.

3. The system of claim 3, wherein the operations further comprise:
rendering the presentation layer on the user device via an interactive voice response system and an avatar rendering engine as a digital consultant interface;
capturing live audio queries from the user device regarding the strategic briefing object;
executing real-time natural language processing and audio transcription on the live audio queries to generate structured machine-readable text arrays;
processing the structured machine-readable text arrays against the metadata payload using a generative artificial intelligence model to automatically generate a machine-readable response dataset;
converting the machine-readable response dataset into synchronized voice audio and visual avatar movements via a speech synthesis to answer live audio queries and generate a real-time answer the; and
receiving the approval signal from the user device following the real-time answer to initiate the parsing of the metadata payload into a plurality of machine instructions.

4. The system of claim 2, wherein each of the plurality of activation signals comprises an agent activation event data structure including the routing path specifying a selected operational track from a predefined set of execution categories and identifying a targeted functional agent.

5. The system of claim 1, wherein the operations further comprise:
retrieving the briefing data object from the shared memory allocation and rendering the presentation layer on the user device during a live interaction with a target entity;
executing real-time natural language processing and audio transcription on live meeting audio to generate a structured machine-readable text array;
performing pattern recognition against the text array to extract target entity needs as service requirement parameters; and
executing deterministic mapping logic to cross-reference the extracted needs against a service database and assign memory pointers to a plurality of solution vectors within the shared memory allocation.

6. The system of claim 5, wherein the operations further comprise:
evaluating the plurality of solution vectors against the current-state data model using parallel processing logic to compute vector similarity scores across a plurality of service parameter tracks;
generating a customized solution data object by synthesizing selected solution parameters with expert inputs received via integrated communication endpoints;
appending supplementary opportunity parameters to the customized solution data object based on predictive analytics against the current-state data model; and
upon receiving an approval signal from the user device, instantiating a discovery findings data structure in the shared memory allocation.

7. The system of claim 6, wherein the operations further comprise:
synthesizing the discovery findings data structure and a plurality of computed value structure vectors to generate a mapped strategy and solution architecture payload;
executing predictive modeling using target-entity-specific metrics to calculate dynamic justification parameters;
generating a digital value proposition data object by transmitting the synthesized mapped strategy and solution architecture payload to an integrated platform via an API endpoint and injecting supplementary metadata into a machine-executable payload of the digital value proposition data object;
transmitting a human-readable presentation layer of the digital value proposition data object to a user device; and
upon receiving an acceptance signal from a target entity user device, generating an agent activation event to update the system configuration and advance to a closure stage.

8. The system of claim 1, wherein the plurality of execution routines comprises a finance agent configured to extract financial request data from an enterprise resource planning system, compile a plurality of reconciliation paths, and execute an accounts payable and accounts receivable reconciliation sequence.

9. A method for automatically orchestrating multi-process execution, comprising:
extracting, by a processor, system data from a plurality of enterprise systems;
generating a current-state data model based on the system data;
generating a briefing data object comprising a presentation layer and a metadata payload;
transmitting the presentation layer to a user device for display on a display of the user device;
receiving an approval signal from the user device associated with the presentation layer;
executing, in response to the approval signal, a deterministic evaluation of the metadata payload against the current-state data model to generate an execution parameter;
parsing, based on the execution parameter, the metadata payload into a plurality of machine instructions using an orchestration routine;
assigning a memory pointer to each machine instruction, each memory pointer referencing a location within a shared memory allocation; and
transmitting a plurality of activation signals to a plurality of execution routines in parallel, wherein each of the plurality of activation signals comprises a machine instruction of the plurality machine instructions and a routing path identifying a respective execution routine.

10. The method of claim 9, wherein executing the deterministic evaluation comprises performing one or more of a threshold comparison, a delta calculation, or a constant-based comparison between the metadata payload and the current-state data model.

11. The method of claim 10, wherein executing the deterministic evaluation further comprises using a rules engine to perform a state comparison and a conflict detection against the current-state data model prior to generating the execution parameter.

12. The method of claim 10, wherein the execution parameter comprises one or more of a resource allocation value, an execution priority, a timeout limit, an estimated impact score, or a calculated cost.

13. The method of claim 11, further comprising:
executing natural language processing against negotiation data to automatically generate a machine-readable objection response data set and transmitting the machine-readable objection response data set to the user device;
displaying final execution terms on a target entity user device and receiving an updated parameter payload;
evaluating whether the target entity has submitted authorization; and
upon absence of authorization, updating the shared memory allocation with escalating timeout parameters and dispatching automated follow-up instructions at each timeout interval until authorization is received or a maximum timeout is exhausted, whereupon updating the current-state data model to reflect a failed state.

14. The method of claim 13, further comprising:
upon receipt of authorization, updating the shared memory allocation to reflect a successful state transition and parsing a finalized metadata payload to generate an execution agreement data object;
executing database insertion instructions to create a new operational record in a natively integrated downstream system;
synthesizing the current-state data model and the execution agreement data object to generate an onboarding plan payload; and
transmitting a completion status flag to the shared memory allocation to confirm the successful state transition and finalize the onboarding phase for multi-process execution.

15. The method of claim 12, further comprising updating the current-state data model in real time from live data feeds extracted from the plurality of enterprise systems to incorporate execution results generated by the plurality of execution routines.

16. A non-transitory machine-readable medium having stored therein instructions executable to cause a machine to perform operations for automatically orchestrating multi-process execution, the operations comprising:
extracting system data from a plurality of enterprise systems;
generating a current-state data model based on the system data;
generating a briefing data object comprising a presentation layer and a metadata payload;
transmitting the presentation layer to a user device for display on a display of the user device;
receiving an approval signal from the user device associated with the presentation layer;
executing, in response to the approval signal, a deterministic evaluation of the metadata payload against the current-state data model to generate an execution parameter;
parsing, based on the execution parameter, the metadata payload into a plurality of machine instructions using an orchestration routine;
assigning a memory pointer to each machine instruction, each memory pointer referencing a location within a shared memory allocation;
transmitting a plurality of activation signals to a plurality of execution routines in parallel; and
updating a portion of the shared memory allocation based on execution results received from the execution routines, wherein each of the plurality of activation signals comprises a machine instruction of the plurality of machine instructions and a routing path identifying a respective execution routine.

17. The non-transitory machine-readable medium of claim 16, wherein the plurality of execution routines comprises a sales agent, a human resources agent, an operation agent, a customer experience agent, a marketing agent, a technology agent, and a finance agent.

18. The non-transitory machine-readable medium of claim 17, wherein each memory pointer assigned to a machine instruction references a location within the shared memory allocation that is readable by a plurality of the execution routines.

19. The non-transitory machine-readable medium of claim 18, wherein the operations further comprise generating a semaphore update or a status flag update by the plurality of execution routines and writing the semaphore update or the status flag update into the shared memory allocation.

20. The non-transitory machine-readable medium of claim 19, wherein the operations further comprise updating the shared memory allocation to include execution result records associated with the plurality of execution routines.
